(19) United States
(12) Patent Application Publication
(10) Pub. No.: US 2011/0276634 A1
(43) Pub. Date: Nov. 10, 2011

(54) NETWORK SYSTEM, COMMUNICATION TERMINAL, COMMUNICATION METHOD, AND COMMUNICATION PROGRAM

(76) Inventors: Kuniyuki Maruyama, Osaka (JP); Toshio Akabane, Osaka (JP); Tatsuya Sakai, Osaka (JP)

(21) Appl. No.: 13/144,068

(22) PCT Filed: May 20, 2010
(86) PCT No.: PCT/JP2010/058520

§ 371 Date: Jul. 11, 2011

(30) Foreign Application Priority Data
May 26, 2009 (JP) 2009-126735

(51) Int. Cl. G06F 15/16

(52) U.S. Cl. 709/205

(57) ABSTRACT

A communication terminal includes an input unit, an interface for communication with another terminal and a first server, a first communication control unit receiving access information for connection with the other terminal and first information from the first server via the interface, and transmitting second information to the first server via the interface, a determination unit determining whether input of the second information satisfies a predetermined condition or not based on access information, and a second communication control unit for exchanging third information with another terminal via the interface based on the access information when input of the second information satisfies the predetermined condition.

### TECHNICAL FIELD

The present invention relates to a network system including a server and a plurality of communication terminals that can be connected through a network, a communication terminal, a communication method, and a communication program. The present invention particularly relates to a network system capable of connecting a plurality of communication terminals with each other, a communication terminal, a communication method, and a communication program.

### BACKGROUND ART

In the field of information presenting service on the Internet, the service of the so-called Weblog (hereinafter, referred to as “blog”) is known. A blog is one type of a Website that is updated on a daily basis. For example, the person who starts a blog (blog establisher; information originator) can post an article related to a Webpage such as news released on the Internet, as well as add a link to the relevant Webpage. A viewer of the blog adds his/her own opinion and/or remarks. The server administering the blog retains the article, together with the added comments in time series.

Such a blog system generally allows entries of comments by blog viewers for every article issued (uploaded) by the blog establisher. The blog system is capable of adding the comment to the relevant article, i.e. storing a comment in correspondence with an article. Both the blog establisher and blog viewer can read comments added to the article.

For example, a blog establisher can send out his/her own comments and/or present situation to many and unspecified persons through the article. The blog establisher can identify the opinions, remarks, questions and the like from blog viewers about an article through the posted comments. The blog establisher can post a new entry reflecting the posted comments.

Thus, a blog system is mainly directed to allowing a blog establisher to express his/her comments. On the other hand, a bulletin board intended to exchanging opinions between a plurality of persons, a chat room created among friends/acquaintances, and a chat system intended to exchanging information through an exclusive communication network are all directed to exchanging opinions on an equal basis with the other party. The “acquaintance” here is not limited to an acquaintance in the real word, and includes an acquaintance in the virtual world such as in the SNS (Social Network Service), a network game, or the like.

Some chat systems allow a plurality of communication terminals to send/receive data with each other without a particular intervening server, such as the P2P communication. In such a chat system, each of the communication terminals can exchange comments, images, and the like in real time through the Internet or the like. In other words, each user of a communication terminal can exchange information in real time by using a chat system.

For example, Japanese Patent Laying-Open No. 2000-181847 (Patent Document 1) discloses a communication support method and communication support system. According to Japanese Patent Laying-Open No. 2000-181847 (Patent Document 1), keywords are accumulated in a keyword list. A keyword detection unit detects that any one of the keywords has been transmitted from another user terminal on any one of the channels. A state detection unit responds to the detection of a keyword to determine the state of the user based on the state of the user's terminal. A notification unit sends out the user state onto the channel through which the keyword has been dispatched. In a destination table, the destination of the user state and the originating source of the keyword are stored in correspondence. The notification unit may notify the destination party determined based on the destination table about the user state. The state of the user called by the keyword is notified in real time to assist the conversation to be carried out smoothly in real time.

Japanese Patent Laying-Open No. 2009-038714 (Patent Document 2) discloses a communication terminal and a computer program thereof. According to Japanese Patent Laying-Open No. 2009-038714 (Patent Document 2), a determination of which of the terminals, i.e. its own terminal or the terminal of the other party, is set as the terminal to initiate a communication action, when matching (arrival) with a communication time and date assigned in the regular schedule data, can be made exclusively based on the value of a conversation action variable registered in the regular schedule data that is exchanged with the terminal of the other party.

Japanese Patent Laying-Open No. 2005-530233 (Patent Document 3) discloses communication allowed between users visiting the same Webpage. According to Japanese Patent Laying-Open No. 2005-530233 (Patent Document 3), the Webpage is activated by clicking an icon on a page. The user can design a character representing herself/himself on the screen. The user can also view other characters on the screen, designed to represent other users. The user can move her/his own character anywhere on the screen by a dragging operation using her/his own mouse. The user can also turn her/his own character to come near or move away from another character. The characters can converse with each other orally or in writing. In the case of text, a balloon (such as an in a cartoon) is displayed for the conversation text. The user can also change the expression of the character to represent her/his emotion (for example, anger). Furthermore, the user can invite another character to a private chat. When the user leaves the Webpage, the relevant character disappears from the screen of all the other users. A program or plug-in software other than a standard Web browser is not required, promoting communication between users viewing the same Webpage. In addition, features such as automatic create or delete of a chat room that were set from the beginning independent of the presence of a user in prior applications can be used.

Japanese Patent Laying-Open No. 2003-091494 (Patent Document 4) discloses a chat system. According to Japanese Patent Laying-Open No. 2003-091494 (Patent Document 4) of a chat system that connects a mobile phone to a chat server to allow a chat between mobile phones, an electronic mail (chat invitation mail) prompting a mobile phone not connected to the chat server to proceed connection with the chat server (participate in the chat) is transmitted. When the user of the mobile phone receiving the chat invitation mail agrees to connect with the chat server (participate in the chat), the mobile phone is automatically connected with the chat server to allow a chat.

Japanese Patent Laying-Open No. 2002-132694 (Patent Document 5) discloses a chat system, a terminal and server using the chat system, and a chat method. According to Japanese Patent Laying-Open No. 2002-132694 (Patent Document 5), a chat request can be sent from a mobile phone to the server, identifying the number of the mobile phone of the other party whom a chat is desired. In response, the server transmits a chat request to the relevant mobile phone of the other party. The other party receiving a chat request responds depending on the circumstances. When a permission of the request is accepted by the other party, the server transmits a request permission to the requesting side. Then, the participant name list is transmitted to all the participants, establishing a chat mode. When the server receives a message from a participant, the server transmits the message to all the participants. The message content is displayed on the screen of the mobile phone of each participant. The other party can participate in the chat from partway of the session.

### PRIOR ART DOCUMENTS

### Patent Documents

Patent Document 1: Japanese Patent Laying-Open No. 2000-181847
Patent Document 2: Japanese Patent Laying-Open No. 2009-038714
Patent Document 3: Japanese Patent Laying-Open No. 2005-530233
Patent Document 4: Japanese Patent Laying-Open No. 2003-091494
Patent Document 5: Japanese Patent Laying-Open No. 2002-132694

### SUMMARY OF THE INVENTION

### Problems to be Solved by the Invention

In the blog system set forth above, communication cannot be established in real time, or directly, between the users of the blog including the blog establisher and blog viewers. For example, it is not possible to allow communication among some of the blog users under the state where the contents of the communication is not revealed to other blog users.

The present invention is directed to solving such a problem, and an object of the present invention is to provide a network system allowing some of blog users including a blog establisher and a blog viewer to establish communication in real time or directly, a communication terminal, a communication method, and a communication program.

### Means for Solving the Problems

According to an aspect of the present invention, a network system including a first terminal, a second terminal, and a first server is provided. The first terminal includes a first input unit for accepting first information, a first terminal interface for communication with the second terminal and the first server, a first display for displaying the first information and second information from the second terminal, and a first terminal control unit for transmitting access information for connection with the first terminal, and the first information to the first server via the first terminal interface. The first server includes a server interface for communication with the first terminal and the second terminal, and a server control unit for transmitting the access information and first information to the second terminal via the server interface, and transmitting the second information from the second terminal to the first terminal via the server interface. The second terminal includes a second input unit for accepting second information, a second terminal interface for communication with the first terminal and the first server, a second display for displaying the first information from the first server and the second information, a first communication control unit for receiving the access information and first information from the first server via the second terminal interface, and transmitting the second information to the first server via the second terminal interface, a determination unit for determining whether input of the second information satisfies a predetermined condition or not based on the access information, and a second communication control unit for exchanging third information with the first terminal via the second terminal interface based on the access information, when the input of the second information satisfies the predetermined condition.

Preferably, the network system further includes a second server. The access information includes a room name. The first terminal control unit transmits the room name and identification information for identifying the first terminal to the second server via the first terminal interface. The second server stores the room name and identification information in correspondence. When input of the second information satisfies the predetermined condition, the second communication control unit obtains the identification information from the second server based on the room name via the second terminal interface, and exchanges the third information with the first terminal via the second terminal interface based on the identification information.

Preferably, the first input unit accepts a keyword. The access information includes a keyword. The determination unit determines whether input of the second information satisfies the predetermined condition or not by determining whether the second information includes the keyword or not.

Preferably, the access information includes a first point of time at which the first terminal transmitted the first information. The determination unit determines whether input of the second information satisfies the predetermined condition or not by determining whether the time starting from the first point of time until the second point of time at which the second terminal transmitted the second information is shorter than a first period of time.

According to another aspect of the present invention, there is provided a communication terminal including an input unit for accepting second information, an interface for communication with another terminal and a first server, a display for displaying first information and second information from the first server, a first communication control unit receiving access information for connection with another terminal and the first information via the interface from the first server, and transmitting the second information to the first server via the interface, a determination unit for determining whether input of the second information satisfies a predetermined condition or not based on the access information, and a second communication control unit for exchanging third information with another terminal via the interface based on the access information when the input of the second information satisfies the predetermined condition.

According to a further aspect of the present invention, there is provided a communication method of a network system including a first terminal, a second terminal, and a first server. The communication method includes the steps of: the first terminal accepting first information, the first terminal transmitting access information for connection with the first terminal and first information to the first server, the first server transmitting the access information and the first information to the second terminal, the second terminal receiving the access information and the first information from the first server, the second terminal accepting second information, the second terminal transmitting the second information to the first server, the second terminal displaying the first information and second information from the first server, the first server transmitting the second information from the second terminal to the first terminal, the first terminal displaying the first information and the second information from the second terminal, the second terminal determining whether input of the second information satisfies a predetermined condition or not based on the access information, and the second terminal exchanging third information with the first terminal based on the access information when the input of a second information satisfies the predetermined condition.

According to still another aspect of the present invention, there is provided a communication method at a communication terminal including a control unit, an input unit, a display, and an interface for communication with another terminal and a first server. The communication method includes the steps of: the control unit receiving access information for connection with another terminal and first information from the first server via the interface, the input unit accepting second information, the control unit transmitting the second information to the first server via the interface, the control unit causing display of the first information and second information from the first server on the display, the control unit determining whether input of the second information satisfies a predetermined condition or not based on the access information, and the control unit exchanging third information with another terminal via the interface based on the access information, when input of the second information satisfies the predetermined condition.

According to a still further aspect of the present invention, there is provided a communication program for causing communication by a communication terminal including a control unit, an input unit, a display, and an interface for communication with another terminal and a first server. The communication program causes the control unit to execute the steps of: receiving access information for connection with another terminal and first information from the first server via the interface, accepting second information via the input unit, transmitting the second information to the first server via the interface, causing display of the first information and second information from the first server on the display, determining whether input of the second information satisfies a predetermined condition or not based on the access information, and exchanging third information with another terminal via the interface based on the access information when input of the second information satisfies the predetermined condition.

According to yet a further aspect of the present invention, there is provided a network system including a first terminal, a second terminal, and a first server. The first terminal includes a first input unit for accepting first information, a first terminal interface for communication with the second terminal and the first server, a first display for displaying the first information and second information from the second terminal, and a first terminal control unit for transmitting access information for connection with the first terminal and the first information to the first server via the first terminal interface. The first server includes a server interface for communication with the first terminal and the second terminal, a determination unit for determining whether input of second information at the second terminal satisfies a predetermined condition or not based on the access information, and a server communication control unit transmitting the first information to the second terminal via the server interface, transmitting the second information from the second terminal to the first terminal via the server interface, and transmitting a portion of the access information to the second terminal via the server interface when input of the second information satisfies the predetermined condition. The second terminal includes a second input unit for accepting second information, a second terminal interface for communication with the first terminal and first server, a second display for displaying the first information from the first server and the second information, a first communication control unit receiving the first information and a portion of the access information from the first server via the second terminal interface, and transmitting the second information to the first server via the second terminal interface, and a second communication control unit for exchanging third information with the first terminal via the second terminal interface based on the portion of the access information.

Preferably, the network system further includes a second server. The access information includes a room name. The first terminal control unit transmits the room name and identification information for identifying the first terminal to the second server via the first terminal interface. The second server stores the room name and identification information in correspondence. The server communication control unit transmits the room name as a portion of the access information to the second terminal via the server interface, when input of the second information satisfies a predetermined condition. The second communication control unit obtains identification information from the second server via the second terminal interface based on the room name, and exchanges third information with the first terminal via the second terminal interface based on the identification information.

Preferably, the access information includes a keyword. The determination unit determines whether input of the second information satisfies the predetermined condition or not by determining whether the second information includes the keyword or not.

Preferably, the access information includes a first point of time at which the first terminal transmitted the first information. The determination unit determines whether input of the second information satisfies the predetermined condition or not based on determining whether the time starting from the first point of time until the second point of time at which the second terminal transmitted the second information is shorter than a first period of time.

According to yet another aspect of the present invention, there is provided a communication method at a network system including a first terminal, a second terminal, and a first server. The communication method includes the steps of: the first terminal accepting first information, the first terminal transmitting access information for connection with the first terminal and the first information to the first server, the first server transmitting the access information and the first information to the second terminal, the second terminal receiving the first information from the first server, the second terminal accepting second information, the second terminal transmitting the second information to the first server, the second terminal displaying the first information and second information from the first server, the first server transmitting the second information from the second terminal to the first terminal, the first terminal displaying the first information and the second information from the second terminal, the first server determining whether input of the second information satisfies a predetermined condition or not, the first server transmitting a portion of the access information to the second terminal when input of the second information satisfies the predetermined condition, and the second terminal exchanging third information with the first terminal based on the portion of the access information.

### Effects of the Invention

According the present invention, there is provided a network system allowing some of blog users including a blog establisher and blog viewers to communicate in real time or directly, a communication terminal, a communication method, and a communication program.

### BRIEF DESCRIPTION OF THE DRAWINGS

FIG. 1 is a schematic diagram of a network system according to a first embodiment.

FIG. 2 represents a sequence of an operation profile at the network system of the first embodiment.

FIG. 3 is a pictorial representation of the transition between display screens of a blog establisher terminal and a blog viewer terminal according to an operation profile of the first embodiment.

FIG. 4 is a block diagram of a hardware configuration of a communication terminal according to the first embodiment.

FIG. 5 is a pictorial representation of data stored in the memory of the communication terminal of the first embodiment.

FIG. 6 is a block diagram of a hardware configuration of a matching server (blog server) according to the first embodiment.

FIG. 7 is a block diagram of a functional configuration of each device in the network system of the first embodiment.

FIG. 8 is a pictorial representation of a display screen of a blog establisher terminal at the time of posting an article according to the first embodiment.

FIG. 9 is a pictorial representation of a display screen of a blog viewer terminal at the time of posting a comment according to the first embodiment.

FIG. 10 is a pictorial representation of a display screen of a blog establisher terminal and a blog viewer terminal after a comment is posted according to the first embodiment.

FIG. 11 represents an example of a message (command) received by the matching server from a communication terminal according to the first embodiment.

FIG. 12 is a flowchart of the procedure of an article post process at a communication terminal that is the terminal of the blog establisher according to the first embodiment.

FIG. 13 is a flowchart of the procedure of a response process at a blog server according to the first embodiment.

FIG. 14 is flowchart of the procedure of a comment post process at a communication terminal that is the terminal of a blog viewer according to the first embodiment.

FIG. 15 is a flowchart of the procedure of a response process at the matching server according to the first embodiment.

FIG. 16 is a schematic diagram of a network system according to a second embodiment.

FIG. 17 represents the sequence of an operation profile at the network system of the second embodiment.

FIG. 18 is a pictorial representation of the data stored in the memory of a blog server according to the second embodiment.

FIG. 19 is a block diagram of the function configuration of each device in the network system of the second embodiment.

FIG. 20 is a flowchart of the procedure of a response process at the blog server of the second embodiment.

FIG. 21 is a flowchart of the procedure of a determination process at the blog server of the second embodiment.

FIG. 22 is a flowchart of the procedure of a comment post process at a communication terminal that is the terminal of a blog viewer of the second embodiment.

### MODES FOR CARRYING OUT THE INVENTION

Embodiments of the present invention will be described hereinafter with reference to the drawings. In the following, the same components have the same reference character allotted. Their designation and function are also identical. Therefore, detailed description thereof will not be repeated.

In the following description, each of a mobile phone and personal computer (hereinafter, PC) will be generically referred to as “communication terminal” when a configuration and/or function common to each of a mobile phone and PC is described. It is to be understood that “communication terminal” is applicable to other information communication equipment such as a PND (Personal Navigation Device), PDA (Personal Data Assistance), and the like.

### First Embodiment

### Entire Configuration of Network System 1

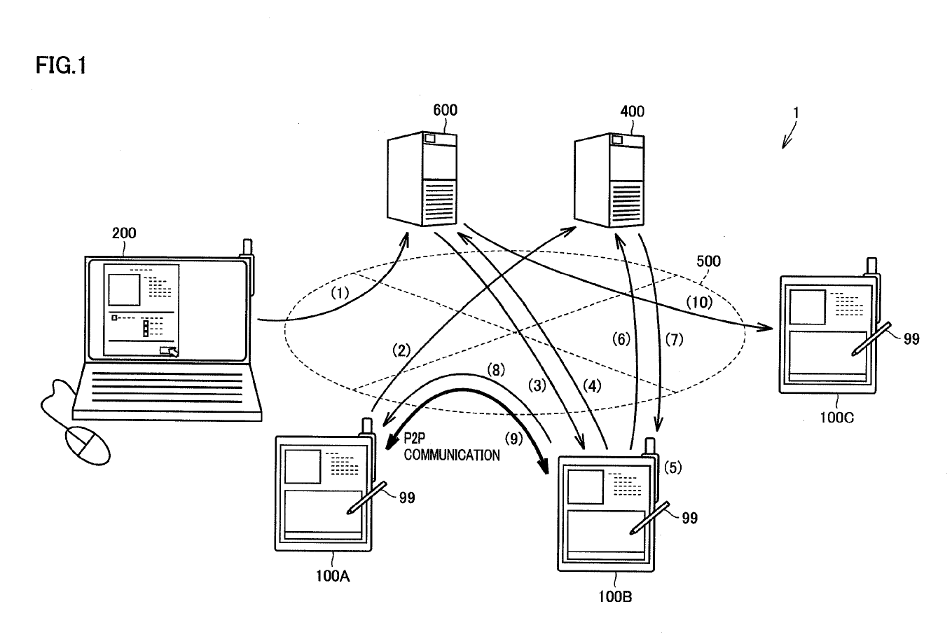

First, a network system 1 according to the present embodiment will be described. FIG. 1 is a schematic diagram of network system 1 of the present embodiment.

Referring to FIG. 1, network system 1 of the present embodiment includes a plurality of mobile phones 100A, 100B, 100C, a PC 200, a matching server 400, a blog server 600, and a network 500 of the Internet.

Each of mobile phones 100A, 100B, 100C, PC 200, matching server 400, and blog server 600 can be connected onto Internet 500. A personal computer 300, mobile phones 100A, 100B, 100C, PC 200, matching server 400, and blog server 600 can be connected onto Internet 500 via a carrier network not shown, a LAN (Local Area Network) 350, or a WAN (Wide Area Network).

Specifically, mobile phones 100A, 100B, 100C, PC 200, matching server 400, and blog server 600 are assigned identification information to identify itself (for example, mail address, IP (Internet Protocol) address, and the like). Mobile phones 100A, 100B, 100C, PC 200, matching server 400, and blog server 600 store the identification information of other communication terminals in its internal storage medium. Accordingly, mobile phones 100A, 100B, 100C, PC 200, matching server 400, and blog server 600 can transmit/receive data to/from another communication terminal via Internet 500 based on the identification information of other communication terminals.

In other words, each communication terminal of the present embodiment can transmit/receive data to/from another communication terminal without an intervening server if its own assigned IP address and/or the IP address assigned to another communication terminal is obtained. Thus, mobile phones 100A, 100B, 100C, PC 200, matching server 400, and blog server 600 constitute the so-called P2P (Pear to Pear) type network by obtaining the IP address of the other communication terminal.

In the present embodiment, it is assumed that an IP address is assigned to each communication terminal at the time of gaining access onto Internet 500 by matching server 400 or another server device not shown. Since the details of the assigning process of an IP address is well known, description thereof will not be repeated here.

<Operation Profile of Network System 1>

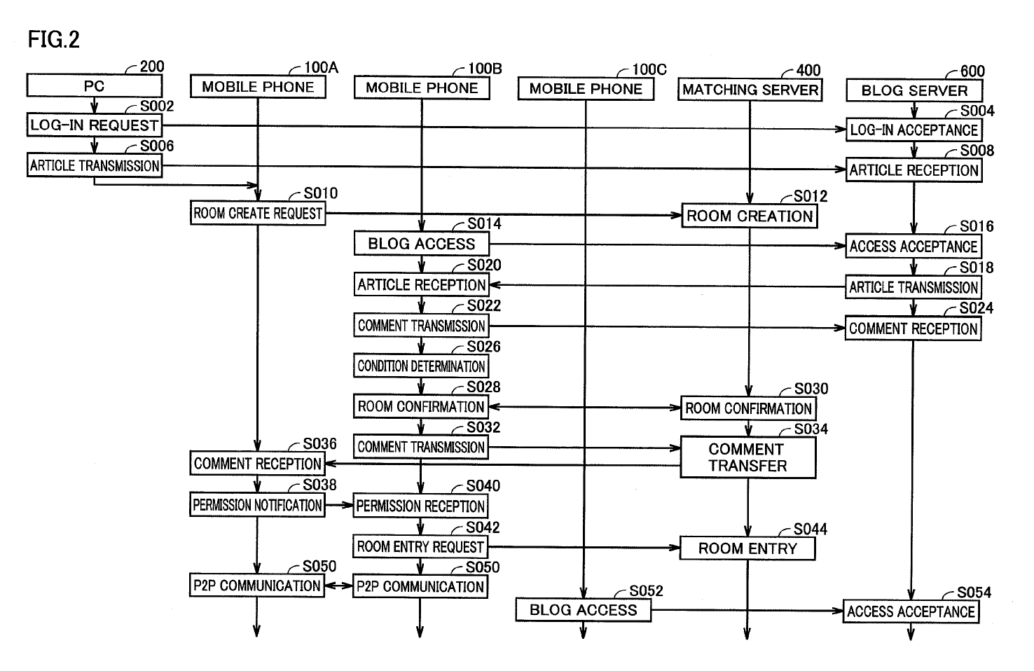

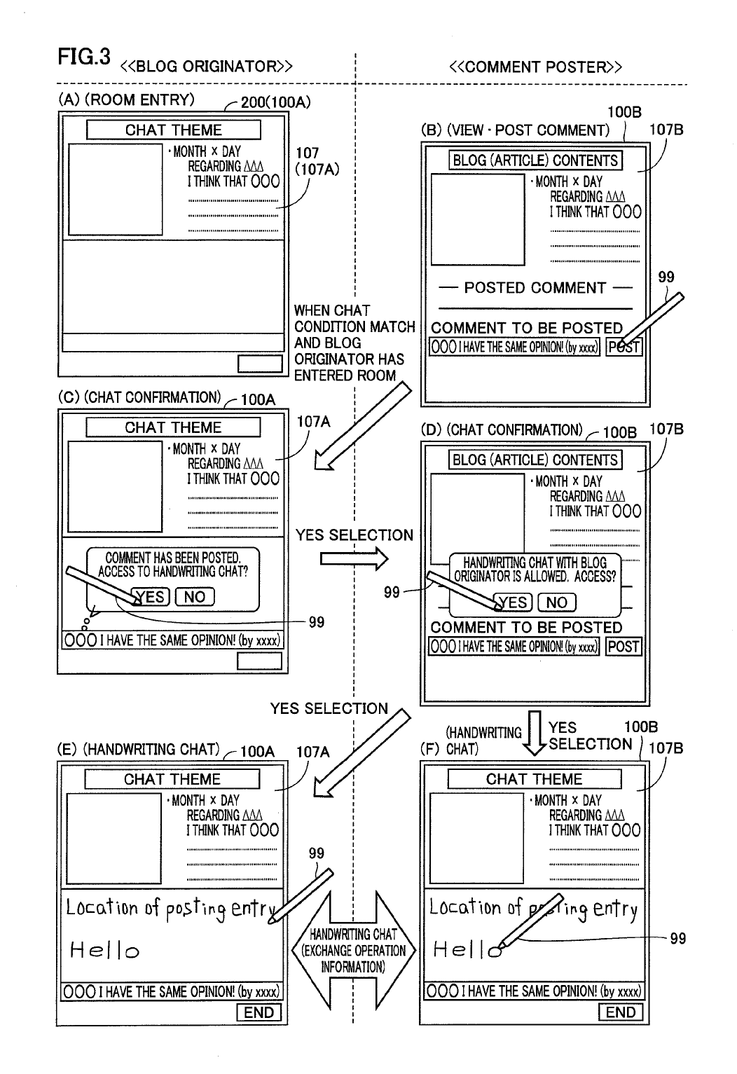

The operation profile of network system 1 according to the present embodiment will be described hereinafter. FIG. 2 represents the sequence of the operation profile of network system 1 of the present embodiment. FIG. 3 is a pictorial representation of the transition between display screens of a blog establisher terminal and a blog viewer terminal according to the operation profile of the present embodiment.

Referring to FIGS. 1, 2 and 3, PC 200 used by a blog establisher requests blog server 600 for the log-in to the blog service (step S002). Blog server 600 receives the request from PC 200 and permits an article to be posted by PC 200 (step S004).

Upon entry of an article at PC 200 by the blog establisher, PC 200 transmits the article to blog server 600 (step S006, FIG. 1 (1)). At this stage, PC 200 accepts from the blog establisher a condition (chat condition) for another communication terminal to conduct a chat communication (P2P communication) with PC 200, and transmits that chat condition and a room name that will be described afterwards to blog server 600 as the access information. Blog server 600 receives and stores the article and chat condition (step S008). Thereafter, blog server 600 responds to a request from a communication terminal to transmit the relevant article to the relevant communication terminal. As shown in FIG. 3 (A), PC 200 displays the page (article) subsequent to article posting.

First mobile phone 100A of the blog establisher sends a request to create a chat room to matching server 400 (step S010). This request includes a room name identical to that in the access information, the IP address of first mobile phone 100A, and the like. Matching server 400 receives the request to create a chat room with the relevant room name (step S012, FIG. 1 (2)). Specifically, matching server 400 stores the room name and the IP address of first mobile phone 100A in correspondence.

Every time PC 200 transmits a new article to blog server 600, mobile phone 100A causes matching server 400 to create a chat room. It is to be noted that first mobile phone 100A may encompass the function of PC 200. Namely, mobile phone 100A may upload the article to blog server 600, and create a chat room at matching server 400.

Second mobile phone 100B responds to a command from a blog viewer to access blog server 600 (step S014). Specifically, second mobile phone 100B requests transmission of the article from blog server 600. Blog server 600 accepts access from second mobile phone 100B (step S016).

Blog server 600 transmits the article and access information to second mobile phone 100B (step S018). Second mobile phone 100B receives the article and access information (step S020), FIG. 1 (3)), and shows the relevant article on the display. At this stage, second mobile phone 100B provides the display of a screen, as shown in FIG. 3 (A).

As shown in FIG. 3 (B), second mobile phone 100B accepts entry of a comment from a blog viewer, and transmits the relevant comment to blog server 600 (step S022), FIG. 1 (4)). Blog server 600 receives the comment from second mobile phone 100B, and stores the comment in correspondence with the article. Thereafter, blog server 600 responds to a request from a communication terminal to down load an article and comment to the relevant communication terminal.

Second mobile phone 100B determines whether the contents of the input comment or the point of time at which the comment was transmitted (point of time of entry) satisfies the chat condition or not (step S026, FIG. 1 (5)). For example, in the case where the chat condition includes a keyword, second mobile phone 100B determines whether the comment includes the keyword or not. Alternatively, in the case where the posting point of time of the article and a specified time or specified point of time are included in the chat condition, second mobile phone 100B determines whether the transmitted point of time of the comment is prior to the specified point of time (point of time of posting+specified time).

When the contents of the input comment or the entered time of the comment satisfies the chat condition, second mobile phone 100B determines whether the chat room is created at matching server 400 based on the room name (step S028, step S030). Second mobile phone 100B transmits the comment to matching server 400 (step S032).

Matching server 400 transfers the comment and the IP address of the second mobile phone 100B to first mobile phone 100A based on the IP address corresponding to the room name (step S034). As shown in FIG. 3 (C), first mobile phone 100A accepts the comment from matching server 400 (step S036), and provides a display of the comment for the blog establisher.

Upon accepting a command asking for chat communication from a blog viewer, first mobile phone 100A notifies second mobile phone 100B that the chat is permitted via matching server 400 (step S038). First mobile phone 100A may also notify second mobile phone 100B that the chat is permitted based on the IP address of second mobile phone 100B. Second mobile phone 100B accepts the permission notification (step S040), and accepts a command asking for a chat communication from the blog viewer, as shown in FIG. 3 (D).

Second mobile phone 100B responds to this command to transmit a request for entering the chat room having the relevant room name to matching server 400, based on the room name (step S042, FIG. 1 (6)). Matching server 400 allows second mobile phone 100B to enter the chat room (step S044). Namely, matching server 400 stores the IP address of second mobile phone 100B and the room name in correspondence.

Matching server 400 transmits the IP address of first mobile phone 100A to second mobile phone 100B (FIG. 1 (7)). Second mobile phone 100B accesses first mobile phone 100A based on the IP address of the first mobile phone 100A (FIG. 1 (8)).

Then, as shown by (E) and (F) in FIG. 3, first mobile phone 100A and second mobile phone 100B conduct a chat communication with each other based on the IP address of the other party (step S050).

Third mobile phone 100C responds to a command from a blog viewer to access blog server 600 (step S052). Specifically, third mobile phone 100C requests transmission of the article from blog server 600. Blog server 600 accepts access from third mobile phone 100C (step S054).

By the configuration set forth above, network system 1 of the present embodiment determines whether second mobile phone 100B permits a chat communication with the first mobile phone 100A according to the comment transmitted by second mobile phone 100B. Namely, a chat communication between first mobile phone 100A and second mobile phone 100B is started or not started depending upon the contents or timing of the comment entered by the blog viewer.

In other words, the blog establisher in network system 1 of the present embodiment can readily select a blog viewer who has entered her/his desired comment and/or who has entered a comment at her/his desired time zone to conduct a chat communication (decide whether to carry out a chat communication or not).

In the present embodiment, a chat communication is carried out between first mobile phone 100A (the terminal of the blog establisher) and second mobile phone 100B (the terminal of the blog viewer). However, a chat communication may be carried out between second mobile phone 100B (terminal of the blog viewer) and a third mobile phone 100C (a terminal of a blog viewer). In this case, the comment from second mobile phone 100B corresponds to the article from the first mobile phone 100A, whereas the comment from third mobile phone 100C corresponds to the comment from second mobile phone 100B.

Namely, the blog viewer enters a chat condition, and second mobile phone 100B transmits the comment and access information for connection with second mobile phone 100B to blog server 600 (up load). Blog server 600 transmits the comment and access information to third mobile phone 100C. Third mobile phone 100C initiates a chat communication with second mobile phone 100B when the entered comment satisfies the chat condition.

A configuration to realize the feature set forth above will be described in detail hereinafter.

<Hardware Configuration of Mobile Phone 100>

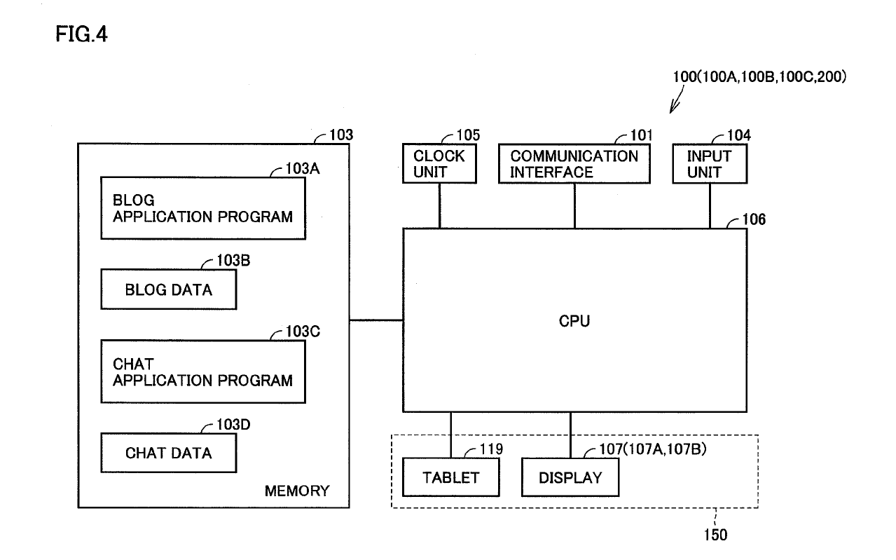

The hardware configuration of mobile phone 100 (PC 200) according to the present embodiment will be described. FIG. 4 is a block diagram of a hardware configuration of a communication terminal according to the present embodiment.

As shown in FIG. 4, the communication terminal of the present embodiment includes a communication interface 101 for transmitting/receiving data to/from an external communication terminal via the network, a memory 103 storing a program and various data, an input unit 104 accepting input of various information, a clock unit 105, a CPU (Central Processing Unit) 106, a display 107, and a tablet 119.

Communication interface 101 converts the communication data from CPU 106 into communication signals, which are issued via an antenna not shown. Communication interface 101 converts the communication signals received via an antenna into communication data, which is applied to CPU 106.

Input unit 104 accepts information from the user through a key input operation or the like. For example, input unit 104 includes a ten-key, a determination key, and the like to accept a select command of the destination address, a comment and the like.

Clock unit 105 measures the current point of time, which is input to CPU 106. Clock unit 105 preferably has a timer function to measure the elapsed time from one point of time.

CPU 106 controls each element of mobile phone 100. CPU 106 reads out a control program from memory 103 to execute the control program. CPU 106 accepts various commands from the user via input unit 104. CPU 106 transmits/receives data to/from an external communication terminal via communication interface 101 and/or a network such as Internet 500.

For example, CPU 106 transmits, via communication interface 101, the article and/or comment accepted via input unit 104, and/or a handwritten image accepted via tablet 119 to blog server 600 or another communication terminal, and receives an article, comment, and/or handwritten image from blog server 600 or another communication terminal. CPU 106 stores an article, comment, and/or handwritten image in memory 103.

Display 107 of the present embodiment is formed of a liquid crystal panel or CRT (Cathode Ray Tube). At the communication terminal of the present embodiment, tablet 119 is provided at the lower side (back side) of display 107. Accordingly, the user can enter graphical information and the like via tablet 119 to CPU 106 using, for example, a stylus pen and/or her/his finger for handwriting input. In other words, display 107 and tablet 119 of the present embodiment constitute the so-called touch panel.

Memory 103 is realized by, for example, a volatile S-RAM (Static-Random Access Memory) functioning as a work memory, a non-volatile ROM (Read Only Memory) for storing a control program or the like, a non-volatile NV-RAM (Non-Volatile Random Access Memory), a non-volatile HDD (Hard Disk Drive) storing still image data, motion image data, and the like. Memory 103 stores an article, comment, the name of a chat room, the IP address of each communication terminal, and the like.

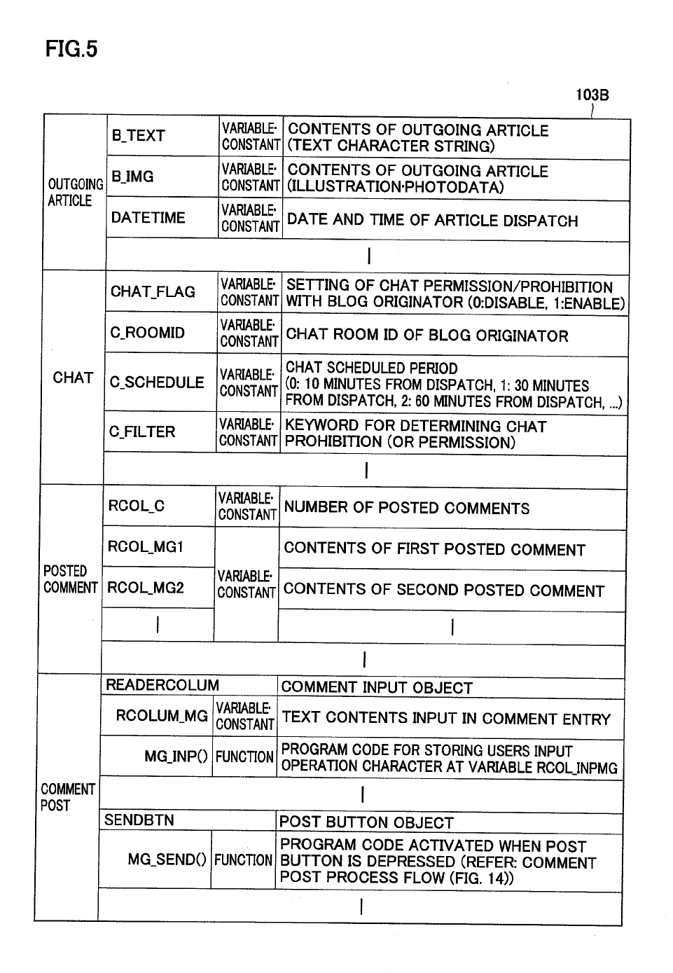

The data stored in memory 103 will be described hereinafter. FIG. 5 is a pictorial representation of blog data 103B stored in memory 103 of the communication terminal according to the present embodiment.

Referring to FIG. 5, memory 103 stores, as information related to the outgoing article, the contents of the outgoing article composed of a string of text characters (B_TEXT), an image of the outgoing article composed of illustrations and/or pictures (B_IMG), and the date of sending out the article (DATETIME).

Memory 103 stores, as information related to a chat, permission/prohibition of a chat with the blog establisher (CHAT_FLAG), the chat room ID of the blog establisher (C_ROOMID), the chat scheduled term (C_SCHEDULE), and a keyword to be used in the determination of chat permission/prohibition (C_FILTER).

Memory 103 stores, as information related to a posted comment, the number of posted comments (RCOL_C), the contents of the first posted comment (RCOL_MG1), the contents of the second posted comment (RCOL_MG2), and the contents of the n-th posted comment (RCOL_MGn).

Memory 103 stores, as information related to a comment currently produced, a comment input object (READRCOLUM), and a post button object (SENDBTN). As the comment input object (READRCOLUM), memory 103 stores the contents of the text currently entered in the comment entry box (RCOLUM_MG), and a program code (MG_INP ( )) for storing the character being entered by the user in a variable RCOLUM_MG.

<Hardware Configuration of Matching Server 400 and Blog Server 600>

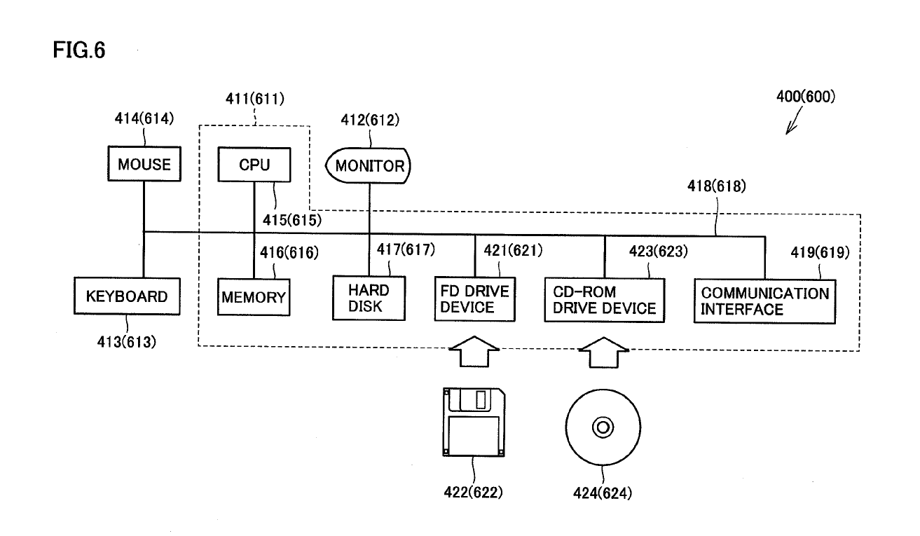

A hardware configuration of matching server 400 of the present embodiment will be described hereinafter. Since the hardware configuration of blog server 600 is identical to that of matching server 400, description thereof will not be repeated. FIG. 6 is a block diagram of a hardware configuration of matching server 400 (blog server 600) of the present embodiment.

Referring to FIG. 6, a matching server main unit 411 (611) includes, in addition to an FD drive device 421 (621) and a CD-ROM drive device 423 (623), a CPU 415 (615), a memory 416 (616) such as an S-RAM, an HDD 417 (617), and a communication interface 419 (619), connected to each other through an internal bus 418 (618). A FD 422 (622) is loaded in FD drive device 421 (621). A CD-ROM 424 (624) is loaded in CD-ROM drive device 423 (623).

A monitor 412 is composed of a liquid crystal panel or CRT to display the information output from CPU 415. Keyboard 413 accepts information from the user by key input. A mouse 414 accepts information from the user through clicking or sliding. Memory 416 stores various information. For example, memory 416 temporarily stores data required when CPU 415 executes a program. HDD 417 stores a program executed by CPU 415 and/or a database.

Communication interface 419 converts the information output from CPU 415 into electric signals. Communication interface 419 converts information output from CPU 415 into signals that can be used by other devices. Communication interface 419 receives externally applied signals to matching server 400 according to the present embodiment, and converts the received signal into information that can be used by CPU 415. Matching server 400 may be connected to another output device such as a printer, as necessary.

CPU 415 controls various elements of matching server 400, and executes various operations. CPU 415 accepts a chat room create request from a communication terminal via communication interface 419. CPU 415 stores a specified room name and the IP address of a communication terminal in correspondence in memory 416. CPU 110 accepts a room name from another communication terminal via communication interface 419 to transmit the IP address corresponding to the relevant room name to the relevant other communication terminal, and stores the IP address of the other communication terminal in correspondence with the relevant room name in memory 416.

The function of matching server 400 (blog server 600) that will be described afterwards is realized by the hardware of matching server 400 (blog server 600) and the software of a control program and the like. In general, such software is available by being stored in a recording medium such as FD 422 or CD-ROM 424, or via a network and the like. The software is read out from the recorded medium by FD drive device 421 or CD-ROM drive device 423, or received at communication interface 419 to be stored in HDD 417. The software is read out from HDD 417 into memory 416 to be executed by CPU 415.

<Function Configuration of Network System 1>

The capability of first mobile phone 100A, second mobile phone 100B, matching server 400 (second server), and blog server 600 (first server) constituting network system 1 of the present embodiment will be described hereinafter. In the following, description is based on the case where first mobile phone 100A is taken as a communication terminal used by the blog establisher, and second and third mobile phones 100B and 100C are taken as communication terminals used by blog viewers.

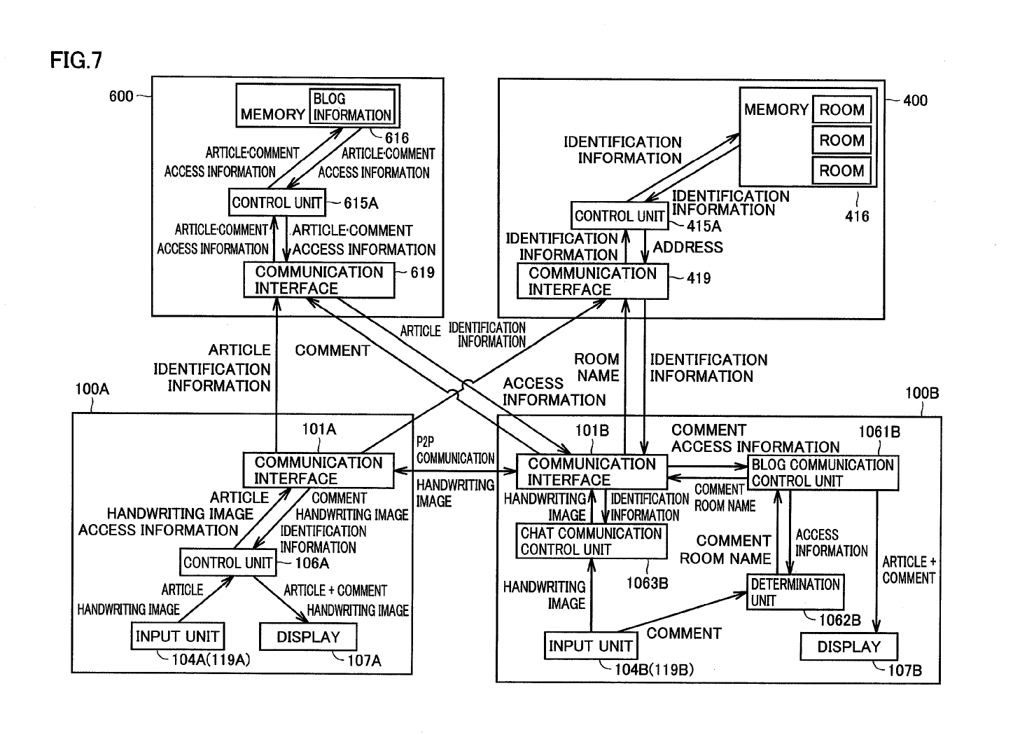

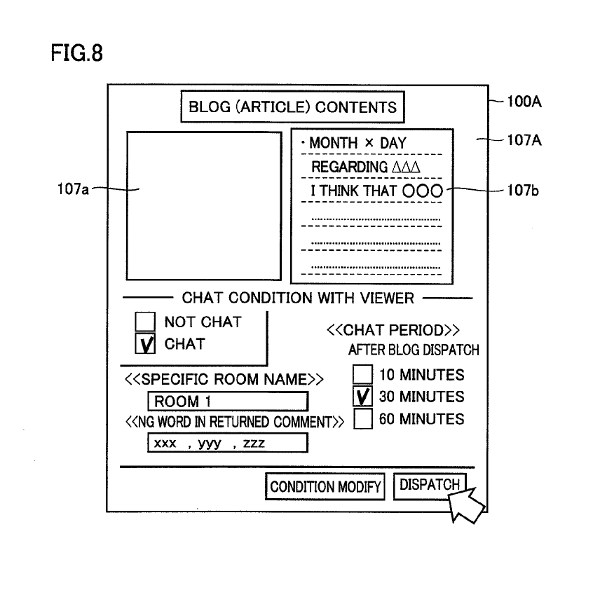

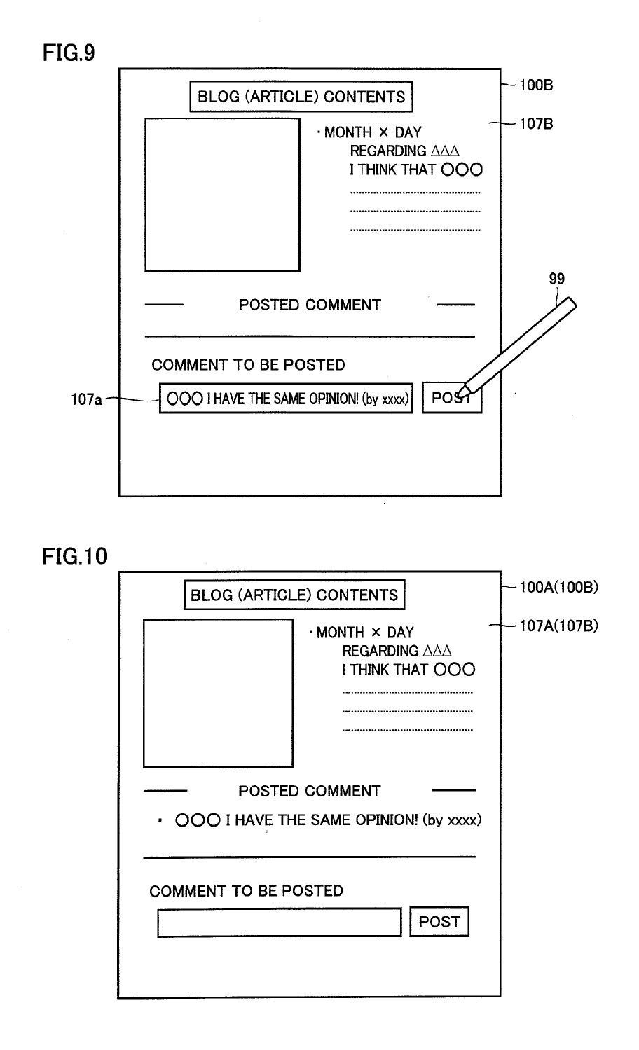

FIG. 7 is a block diagram of a function configuration of each device in network system 1 of the present embodiment. FIG. 8 is a pictorial representation of the display screen of the blog establisher terminal in an article post mode of the present embodiment. FIG. 9 is a pictorial representation of the display screen of a blog viewer terminal in a comment post mode of the present embodiment. FIG. 10 is a pictorial representation of a display screen of the blog establisher terminal and blog viewer terminal after a comment has been posted in the present embodiment.

First, the function configuration of first mobile phone 100A according to the present embodiment will be described with reference to FIG. 7. First mobile phone 100A includes a communication interface 101A, a control unit 106A, a display 107A, and an input unit 104A (tablet 119A), in addition to memory 103, clock unit 105, and the like described previously.

Input unit 104A accepts the entry of an article (first information) or comment (second information) from users to provide the relevant article and/or comment to control unit 106A. Control unit 106A stores the relevant article and/or comment in memory 103. Tablet 119 accepts a handwritten image (third information) from the user to provide the handwritten image to control unit 106A. Control unit 106A stores the handwritten image in memory 103.

Display 107A displays text such as an article or comment and/or an image such as an illustration or picture, based on the data from control unit 106A. In the present embodiment, display 107A shows an article, comment, handwritten image, and the like based on the data from control unit 106A.

Communication interface 101A is realized by a communication antenna and/or signal processor not shown. Communication interface 101A transmits various data to blog server 600, matching server 400, and/or another communication terminal via Internet 500, and receives various data from blog server 600, matching server 400, and/or another communication terminal. Communication interface 101A of the present embodiment transmits the article or comment to blog server 600 via Internet 500. Communication interface 101A transmits/receives a handwritten image during chat communication to/from second mobile phone 100B.

Control unit 106A is realized by a CPU 106 and a control program stored in memory 103. Specifically, each function (module) of control unit 106A is realized by CPU 106 executing a control program stored in memory 103 and the like to control each hardware shown in FIG. 4. For example, CPU 106 implements a functional block corresponding to control unit 106A by reading a program prestored in a ROM, HDD, or the like constituting the non-volatile memory of memory 103 into an S-RAM realizing a work memory of the same memory 103 for execution.

As shown in FIG. 8, control unit 106A causes display 107A to show text 107b and/or image 107a for article entry, and also the text or image to accept a chat condition. Control unit 106A accepts the contents of an article and/or chat condition via input unit 104. In the present embodiment, control unit 106A accepts the permission/prohibition of chat communication and/or the room name of the chat room. Control unit 106A accepts, as the chat condition, a keyword, an NG word, and/or a chat communication allowable term.

Control unit 106A uses communication interface 101A to transmit the article accepted from the user to blog server 600 via Internet 500. At the same time, control unit 106A uses communication interface 101A to transmit the room name and chat condition accepted from the user to blog server 600 as the access information.

Control unit 106A uses communication interface 101A to request matching server 400 to create a chat room. At the stage of this request, control unit 106A transmits its own assigned IP address (identification information) and the room name to matching server 400.

Control unit 106A uses communication interface 101A to carry out a chat communication with second mobile phone 100B. Specifically, at the initiation of a chat communication, control unit 106A obtains the IP address of second mobile phone 100B from second mobile phone 100B.

During a chat communication, control unit 106A transmits a handwritten image and/or comment accepted from the user via tablet 119A and/or input unit 104A to second mobile phone 100B based on the IP address thereof using communication interface 101A. Control unit 106A uses communication interface 101A to receive a handwritten image and/or comment from second mobile phone 100B.

Control unit 106A stores the article and/or comment received from the user via input unit 104, or received from blog server 600 by means of communication interface 101A into memory 103, and causes the relevant article and/or comment to be displayed at display 107A. Control unit 106A causes the handwritten image accepted from the user via tablet 119, or the handwritten image received from second mobile phone 100B by means of communication interface 101A at display 107A.

A function configuration of blog server 600 of the present embodiment will be described hereinafter. Blog server 600 includes a control unit 615A, a memory 616, and a communication interface 619.

As described before, communication interface 619 is realized by a communication antenna and/or signal processor not shown. Communication interface 619 transmits various data to a communication terminal, and receives various data from a communication terminal via Internet 500. Communication interface 619 of the present embodiment receives an article and/or comment via Internet 500, and transmits the relevant article and/or comment to another communication terminal.

Control unit 615A is a function realized by CPU 615 and a control program or the like stored in memory 616. Specifically, each function of control unit 615A is a function (module) realized by CPU 615 executing a control program stored in memory 616 and the like to control each hardware shown in FIG. 4. For example, CPU 615 implements a functional block corresponding to control unit 615A by reading out a program prestored in HDD 617 and the like into a memory 616 such as an S-RAM for execution.

Control unit 615A receives from first mobile phone 100A the access information related to first mobile phone 100A and the article to store the access information and article in memory 616 via communication interface 619. Control unit 615A responds to a request from second mobile phone 100B to transmit the relevant access information and article to second mobile phone 100B via communication interface 619.

Control unit 615A receives the access information related to second mobile phone 100B and a comment from second mobile phone 100B via communication interface 619 to store the access information and comment in memory 616. Control unit 615A responds to a request from first mobile phone 100A or third mobile phone 100C to transmit the relevant access information and comment to first mobile phone 100A or third mobile phone 100C via communication interface 619.

A function configuration of second mobile phone 100B according to the present embodiment will be described hereinafter. Second mobile phone 100B includes a communication interface 101B, a blog communication control unit 1061B, a determination unit 1062B, a chat communication control unit 1063B, a display 107B, and an input unit 104B (tablet 119B). As mentioned above, second mobile phone 100B also includes memory 103, a clock unit 105, and the like.

Input unit 104B accepts entry of a comment (second information) from the user, and provides the comment to CPU 106 implementing blog communication control unit 1061B and determination unit 1062B. CPU 106 stores the comment in memory 103. Tablet 119 accepts a handwritten image (third information) from the user, and provides the handwritten image to CPU 106. CPU 106 stores the handwritten image in memory 103.

Display 107B shows the text of an article or comment, and/or an image such as an illustration or picture, based on the data from CPU 106. In the present embodiment, display 107B displays an article, comment, handwritten image, or the like, based on the data from CPU 106.

Communication interface 101B is realized by a communication antenna and/or signal processing not shown. Communication interface 101B transmits/receives various data to/from blog server 600, matching server 400, or another communication terminal via Internet 500. Communication interface 101B of the present embodiment transmits a comment to blog server 600 via Internet 500. Communication interface 101B transmits/receives a handwritten image during a chat communication to/from second mobile phone 100B.

Blog communication control unit 1061B, determination unit 1062B, and chat communication control unit 1063B are functions realized by CPU 106 and a control program stored in memory 103. Specifically, each function of CPU 106 is a function (module) realized by CPU 106 executing a control program stored in memory 103 and the like to control each hardware shown in FIG. 4.

For example, CPU 106 implements a functional block corresponding to blog communication control unit 1061B, determination unit 1062B, and chat communication control unit 1063B by reading out a program prestored in a ROM, HDD, or the like realizing a non-volatile memory of memory 103 into an S-RAM realizing a work memory of memory 103 for execution.

As shown in FIG. 9, blog communication control unit 1061B receives access information and an article from blog server 600 to cause display 107A to show an article. Blog communication control unit 1061B causes display 107A to show text 107C for comment entry, and accepts a comment via input unit 104. Blog communication control unit 1061B uses communication interface 101B to transmit the comment accepted from a user to blog server 600 via Internet 500.

Blog communication control unit 1061B receives from blog server 600 the article posted by first mobile phone 100A and the comment posted by second mobile phone 100B, as the contents of the blog subsequent to comment posting. As shown in FIG. 10, blog communication control unit 1061B causes display 107 to show the contents of the blog subsequent to comment posting.

When blog communication control unit 1061B transmits a comment to blog server 600, determination unit 1062B determines, based on the access information, whether the input comment (transmission) satisfies the chat condition included in the access information.

For example, when the chat condition includes a keyword, determination unit 1062B determines whether the predetermined condition is satisfied or not by determining whether the input (transmitted) comment includes the keyword or not.

When the chat condition includes an NG word, determination unit 1062B determines whether the predetermined condition is satisfied or not by determining whether the input (transmitted) comment includes the NG word or not.

In the case where the chat condition includes a posting time and a chat allowable term, determination unit 1062B determines whether the predetermined condition is satisfied or not by determining whether the comment input point of time (transmission point of time) is within a chat allowable term from the posted time.

When the predetermined condition is satisfied, blog communication control unit 1061B or chat communication control unit 1063B requests matching server 400 for the IP address of first mobile phone 100A based on the room name included in the access information.

Chat communication control unit 1063B uses communication interface 101B to carry out a chat communication with first mobile phone 100A based on the IP address from matching server 400. During a chat communication, chat communication control unit 1063B transmits, using communication interface 101B, a handwritten image and/or comment accepted from the user via tablet 119B and/or input unit 104B to first mobile phone 100A based on the IP address of first mobile phone 100A. Chat communication control unit 1063B uses communication interface 101B to receive a handwritten image and/or comment from first mobile phone 100A.

A function configuration of matching server 400 according to the present embodiment will be described hereinafter. Matching server 400 includes a control unit 415A, a memory 416, and a communication interface 419.

As set forth above, communication interface 419 is realized by a communication antenna and/or signal processing not shown. Communication interface 419 transmits/receives various data to/from a communication terminal through Internet 500 or the like. Communication interface 419 of the present embodiment receives a room name and an IP address from a communication terminal via Internet 500 and transmits the relevant IP address to another communication terminal via Internet 500.

Control unit 415A is a function realized by CPU 415 and a control program or the like stored in memory 416. Specifically, each function of control unit 415A is a function (module) realized by CPU 415 executing a control program stored in memory 416 or the like to control each hardware shown in FIG. 4. For example, CPU 415 implements a functional block corresponding to control unit 415A by reading out a program prestored in HDD 417 or the like into memory 416 such as an S-RAM or the like for execution.

Control unit 415A receives a chat room create request from first mobile phone 100A via communication interface 419 to create the chat room of the room name included in the request. Specifically, control unit 415A stores a room name and an IP address of the relevant communication terminal included in the request in correspondence into memory 416.

Control unit 415A receives a room name from second mobile phone 100B via communication interface 419 to transmit the IP address corresponding to the relevant room name to second mobile phone 100B. At this stage, control unit 415A stores the IP address of second mobile phone 100B in correspondence with the room name in memory 416.

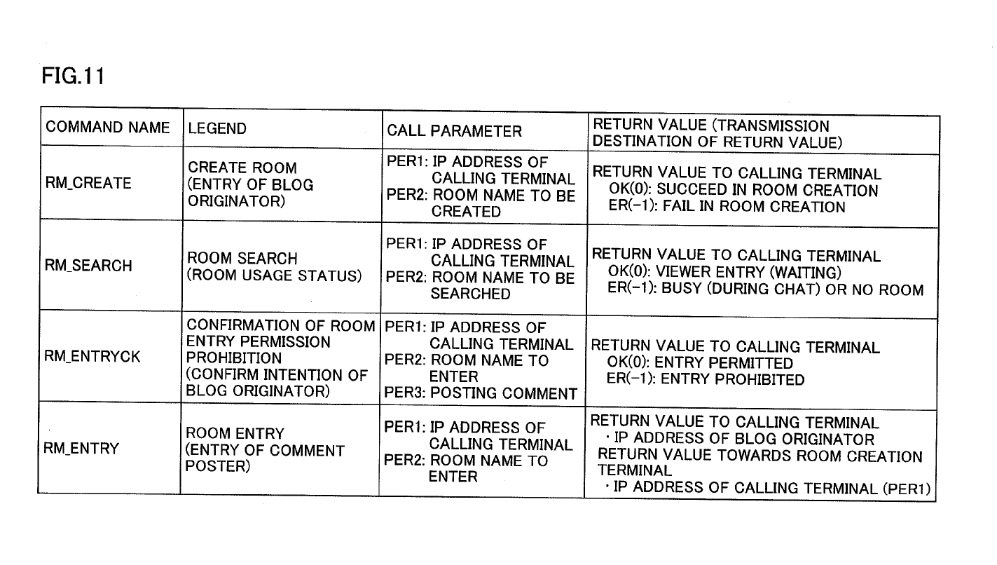

A message (command) accepted by matching server 400 from a communication terminal will be described hereinafter. FIG. 11 represents an example of a message (command) that matching server 400 receives from a communication terminal.

Referring to FIG. 11, a create request includes a message to request creation of a room. The command designation thereof is “RM_CREATE”. First mobile phone 100A transmits the IP address of first mobile phone 100A and the name of the room to be created as the create request. Matching server 400 accepts the create request and creates a new room corresponding to the room name. Matching server 400 returns a message indicating whether creation of the room has succeeded or not to first mobile phone 100A.

A search request includes a message to request the search of a room. The command designation thereof is “RM_SEARCH”. Second mobile phone 100B transmits the room name to be searched in order to obtain the IP address of first mobile phone 100A, as a search request. Matching server 400 accepts a search request to determine whether the room name is stored or not. Matching server 400 returns a message indicating whether there is a room with the room name.

A room entry permission/prohibition request includes a message to confirm whether entry to the chat room is allowed or not (permitted or not). The command designation thereof is “RM_ENTRYCK”. Second mobile phone 100B transmits the room name to be confirmed as a room entry permission/prohibition request. Matching server 400 accepts a room entry permission/prohibition request to determine whether entry to the chat room with the relevant room name is permitted or not. Matching server 400 returns a message indicating whether entry to the chat room with the relevant room name is permitted or not.

A room entry request includes a message to enter a room. The command designation thereof is “RM_ENTRY”. Second mobile phone 100B transmits the IP address of second mobile phone 100B and the name of the room to enter, as the room entry request. Matching server 400 accepts the room entry request, and stores the IP address of second mobile phone 100B in correspondence with the room name in memory 416. Matching server 400 returns a message indicating whether entry into the room has succeeded or not.

<Article Post Process>

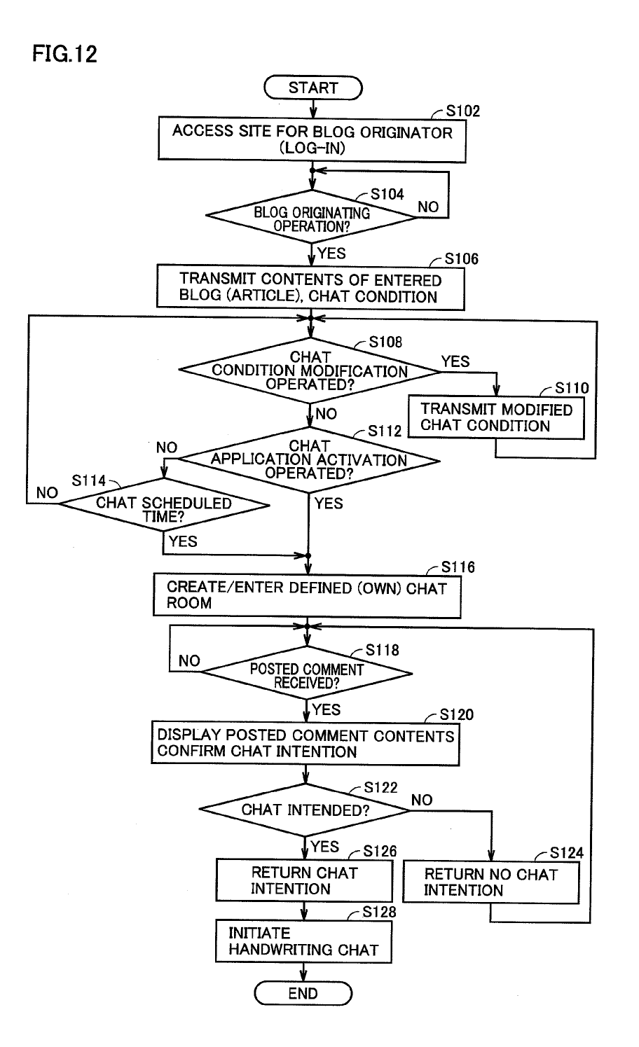

The procedure of an article post process at a communication terminal identified as the blog establisher terminal of the present embodiment will be described. FIG. 12 is a flowchart of the procedure of an article post process at a communication terminal identified as the blog establisher terminal of the present embodiment.

Referring to FIG. 12, CPU 106 accesses a blog establisher site of blog server 600 via communication interface 101 (step S102). CPU 106 determines whether an operation of posting an article on the blog is accepted or not from a user via input unit 104 or tablet 119 (step S104). When an operation of posting an article was not accepted (NO at step S104), CPU 106 repeats the process from step S104.

When an operation of posting an article is accepted (YES at step S104), CPU 106 transmits the contents of the input article and chat condition to blog server 600 via communication interface 101 (step S106). CPU 106 determines whether an operation of modifying the chat condition has been accepted from the user via input unit 104 or tablet 119 (step S108). When an operation of modifying the chat condition is accepted (YES at step S108), CPU 106 transmits the modified chat condition to blog server 600 via communication interface 101 (step S110). CPU 106 repeats the process from step S108.

When an operation of modifying the chat condition is not accepted (NO at step S108), CPU 106 determines whether a chat application activation request is accepted from the user or not via input unit 104 or tablet 119 (step S112). When a chat application activation request is not accepted (NO at step S112), CPU 106 refers to clock unit 105 to determine whether the time has arrived at the chat scheduled point of time (step S114). When the time has not arrived at the chat scheduled point of time (NO at step S114), CPU 106 repeats the process from step S108.

When the time has arrived at the chat scheduled point of time (YES at step S114), or when a chat application activation operation is accepted (YES at step S112), CPU 106 transmits a request to create a chat room to the matching server via communication interface 101 (step S116). In other words, the communication terminal identified as the blog establisher terminal enters the created chat room. CPU 106 determines whether a posted comment is received or not via communication interface 101 (step S118). When a posted comment is not received from the matching server (NO at step S118), CPU 106 repeats the process from step S118.

When a posted comment is received from the matching server (YES at step S118), CPU 106 causes display 107 to show the contents of the posted comment, and prompts the user to input a command as to whether a chat communication is to be carried out or not (step S120). When a command of not carrying out a chat communication is accepted from the user (NO at step S122), CPU 106 returns a message of not carrying out a chat communication to matching server 400 via communication interface 101 (step S124). CPU 106 repeats the process from step S118.

When a command of carrying a chat communication is accepted from the user (YES at step S122), CPU 106 returns a message of carrying out a chat communication to matching server 400 via communication interface 101 (step S126). CPU 106 initiates a handwriting chat communication with another communication terminal that is a blog viewer terminal via communication interface 101 (step S128). In other words, the communication terminal identified as a blog establisher terminal initiates a chat communication with a communication terminal that is a blog viewer terminal.

<Response Process at Blog Server>

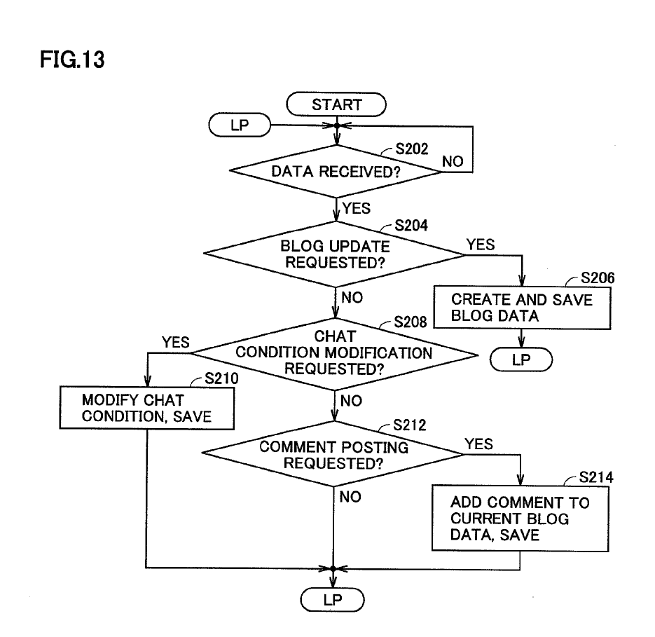

The procedure of a response process by blog server 600 of the present embodiment will be described hereinafter. FIG. 13 is a flowchart of the procedure of a response process by blog server 600 of the present embodiment.

Referring to FIG. 13, CPU 615 determines whether data is received from a communication terminal via communication interface 619 (step S202). When data is not received (NO at step S202), CPU 615 repeats the process from step S202.

When data is received (YES at step S202), CPU 615 determines whether the relevant data is a blog update request or not (step S204). When a blog update request is accepted (YES at step S204), CPU 106 generates blog data and stores the data at a predetermined address in memory 616 (a predetermined address where the relevant blog data can be viewed by an arbitrary terminal such as third mobile phone 100C capable of connection on Internet 500 by gaining access through browser software or the like) based on the article and/or chat condition included in the blog request (step S206). CPU 615 repeats the process from step S202.

When a blog update request is not received (NO at step S204), CPU 615 determines whether the relevant data is a request of modifying the chat condition (step S208). When a chat condition modify request is accepted (YES at step S208), CPU 106 modifies the chat condition based on the modify request, and stores the modified chat condition at a predetermined address in memory 616 (step S210). CPU 615 repeats the process from step S202.

When a chat condition modify request is not accepted (NO at step S208), CPU 106 determines whether the relevant data is a comment post request or not (step S212). When a comment post request is not received (NO at step S212), CPU 106 repeats the process from step S202.

When a comment post request is received (YES at step S212), CPU 106 adds the comment to the current blog data, and stores the new blog data at a predetermined address in memory 616 (step S214). CPU 615 repeats the process from step S202.

<Comment Post Process>

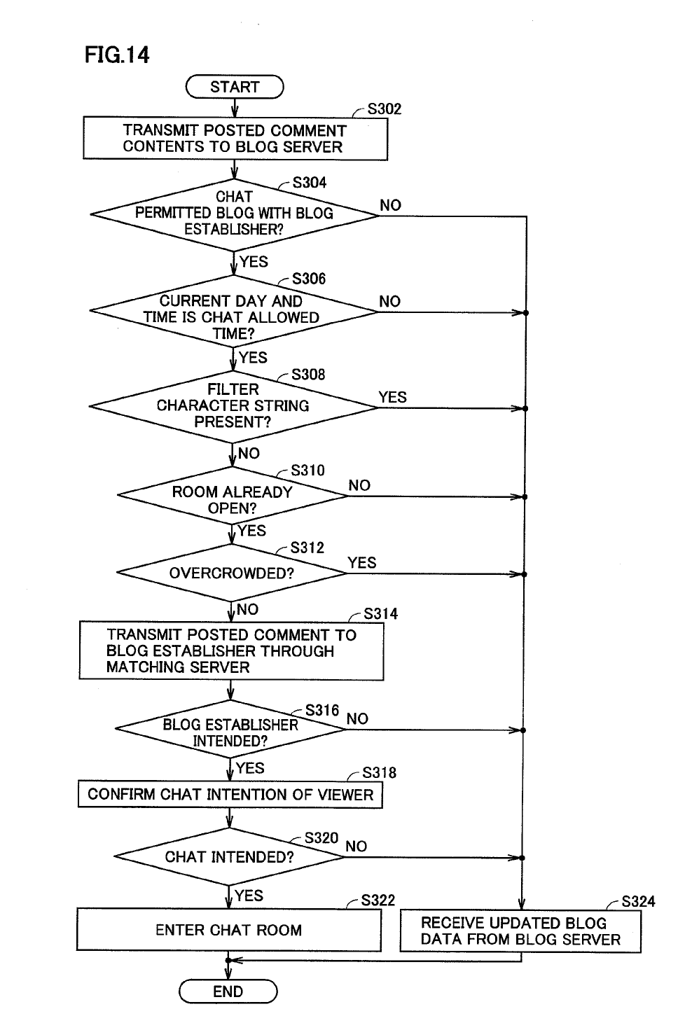

The procedure of a comment post process at a communication terminal identified as a blog viewer terminal of the present embodiment will be described hereinafter. FIG. 14 is a flowchart of the procedure of a comment post process at a communication terminal identified as a blog viewer terminal of the present embodiment.

Referring to FIG. 14, CPU 106 accepts a posted comment from a user via input unit 104 or tablet 119, and transmits the relevant comment to blog server 600 via communication interface 101 (step S302). CPU 106 asks blog server 600 whether a chat with the blog establisher is allowed or not in association with the blog currently viewed by second mobile phone 100B (step S304).

When a chat with the blog establisher is not allowed (NO at step S304), CPU 106 receives (reloads) the updated (most recent) blog data from blog server 600 via communication interface 101 (step S324).

When a chat with the blog establisher is allowed (YES at step S304), CPU 106 determines whether the current date and time belongs to a chat allowable time zone (step S306). When the current time and date does not belong to a chat allowable time zone (NO at step S306), i.e. the chat allowable time zone has ended, CPU 106 repeats the process from step S324.

When the current date and time belongs to a chat allowable time zone (YES at step S306), CPU 106 determines whether a filter character string (NG word) is included in the posted comment (step S308). When an NG word is included in the comment (YES at step S308) CPU 106 repeats the process from step S324.

When an NG word is not included in the comment (NO at step S308), CPU 106 asks whether the chat room is already open or not at matching server 400 via communication interface 101 (step S310). When the chat room is not yet open (NO at step S310), CPU 106 repeats the process from step S324.

When the chat is already open (YES at step S310), CPU 106 determines whether the number of participants entering the chat room has arrived at the quota (step S312). When the number of participants entering the chat room has arrived at the quota (YES at step S312). CPU 106 repeats the process from step S324.

When the number of participants entering the chat room has not arrived at the quota (NO at step S312), CPU 106 transmits the posted comment through matching server 400 to the communication terminal of the blog establisher via communication interface 101 (step S314). CPU 106 determines whether the blog establisher has permitted a chat communication at matching server 400 via communication interface 101 (step S316). When a chat communication is not permitted (NO at step S316), CPU 106 repeats the process from step S324.

When a chat communication is permitted (YES at step S316), CPU 106 confirms whether a viewer of the blog permits a chat communication or not (step S318). When a chat communication is not permitted (NO at step S320), CPU 106 repeats the process from step S324.

When a chat communication is permitted (YES at step S320), CPU 106 enters the chat room at matching server 400 via communication interface 101 (step S322). CPU 106 activates a handwriting chat application, and ends other browsers.

<Response Process by Matching Server 400>

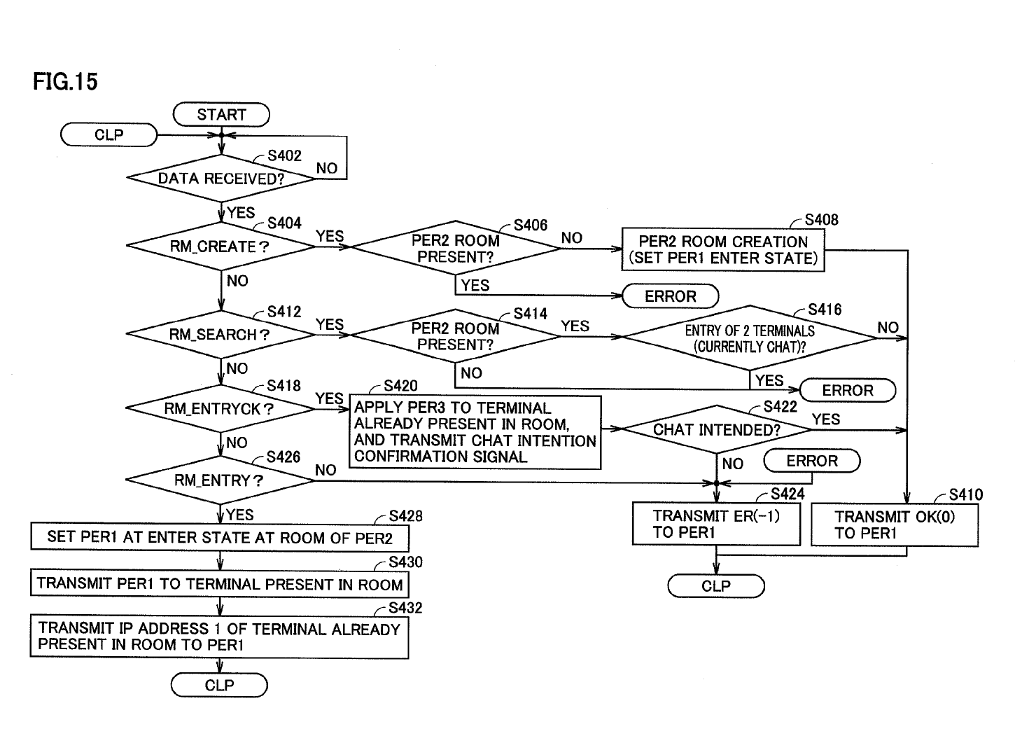

The procedure of a response process by matching server 400 of the present embodiment will be described hereinafter. FIG. 15 is a flowchart of the procedure of a response process by matching server 400 of the present embodiment.

Referring to FIG. 15, CPU 415 of matching server 400 waits for a message from a communication terminal via communication interface 419 (step S402). When a message is accepted from a communication terminal (YES at step S402), CPU 415 determines whether the message is a create request to create a chat room (step S404).

When the message is a create request to create a chat room (YES at step S404), CPU 415 determines whether the room name included in the create request is stored in memory 416 or not (step S406). When the room name is stored in memory 416 (YES at step S406), CPU 415 notifies the relevant communication terminal that creation of the chat room has failed via communication interface 419, based on the IP address of the communication terminal transmitting the message (step S424). CPU 415 repeats the process from step S402.

When the room name is not stored in memory 416 (NO at step S406), CPU 415 creates a room of the relevant room name (step S408). In other words, CPU 415 stores the room name and the IP address of the communication terminal included in the create request into memory 416 in correspondence. CPU 415 notifies the relevant communication terminal that creation of the room has succeeded based on the IP address of the communication terminal via communication interface 419 (step S410).

When the message is not a create request to create a chat room (NO at step S404), CPU 415 determines whether the message is a search request to search for a room name (step S412).

When the message is a search request to search for a room name (YES at step S412), a determination is made as to whether the room name included in the search request is stored in memory 416 (step S414). When the room name is stored in memory 416 (YES at step S414), CPU 415 determines whether the number of communication terminals entering the chat room is equal to or greater than a predetermined value, i.e. whether the chat room has arrived at its quota (step S416). When the chat room has not arrived at the quota (NO at step S416), CPU 416 sends a notification that the room has been found to communication interface 419 based on the IP address of the communication terminal (step S410). CPU 415 repeats the process from the step S402.

When the room name is not stored in memory 416 (NO at step S414), or when the chat room has arrived at its quota (YES at step S416), CPU 415 notifies the relevant communication terminal of an error via communication interface 419 based on the IP address of the communication terminal sending the message (step S424). CPU 415 repeats the process from step S402.

When the message is not a search request for searching for a chat room (NO at step S412), CPU 415 determines whether the message is an inquiry about chat communication permission/prohibition (step S418).

When the message is an inquiry about chat communication permission/prohibition (YES at step S418), CPU 415 refers to the room name in the message via communication interface 419 to ask the communication terminal based on the IP address corresponding to the relevant room name whether a chat communication is to be permitted or not (step S420). At this stage CPU 415 also transmits the comment to the relevant communication terminal. CPU 415 determines whether the communication terminal has permitted a chat communication or not based on the response from the relevant communication terminal (step S422).

When a chat communication is permitted (YES at step S422), CPU 415 notifies the relevant communication terminal that a chat communication is permitted, based on the IP address of the communication terminal transmitting the inquiry (step S410). CPU 415 repeats the process from step S402.

When a chat communication is not permitted (NO at step S422), CPU 106 notifies the relevant communication terminal that a chat communication is not permitted based on the IP address of the communication terminal transmitting the message (step S424), and repeats the process from step S402.

When the message is not an inquiry about chat communication permission/prohibition (NO at step S418), CPU 415 determines whether the message is a room entry request to enter the chat room (step S426).

When the message is a room entry request to enter the chat room (YES at step S426), CPU 415 registers the IP address of the communication terminal transmitting the message in correspondence with the room name into memory 416 (step S428).

CPU 415 transmits, via communication interface 419, the IP address of the communication terminal transmitting the message to another communication terminal already participating in the chat room based on the IP address stored in memory 416 in correspondence with the room name (step S430). CPU 106 transmits, via communication interface 419, the IP address of another communication terminal to communication interface 101A transmitting the message (step S432). CPU 415 repeats the process from step S402.

When the message is not a room entry request to enter the chat room (NO at step S426), CPU 415 transmits an error message to the communication terminal based on the IP address of communication interface 101A transmitting the message (step S424), and repeats the process from step S402.

### Second Embodiment

A second embodiment of the present invention will be described hereinafter. Network system 1 of the previous first embodiment has the determination of whether to carry out a chat communication or not conducted by the communication terminal identified as a blog viewer terminal. In contrast, network system 1 of the present embodiment has the determination of whether to carry out a chat communication or not conducted by blog server 600.

The entire configuration of network system 1 of the second embodiment, the hardware configuration of each device constituting into network system 1 (first mobile phone 100A, second mobile phone 100B, third mobile phone 100C, PC 200, matching server 400, blog server 600) are similar to those of the first embodiment. Therefore, description thereof will not be repeated.

<Operation Profile of Network System 1>

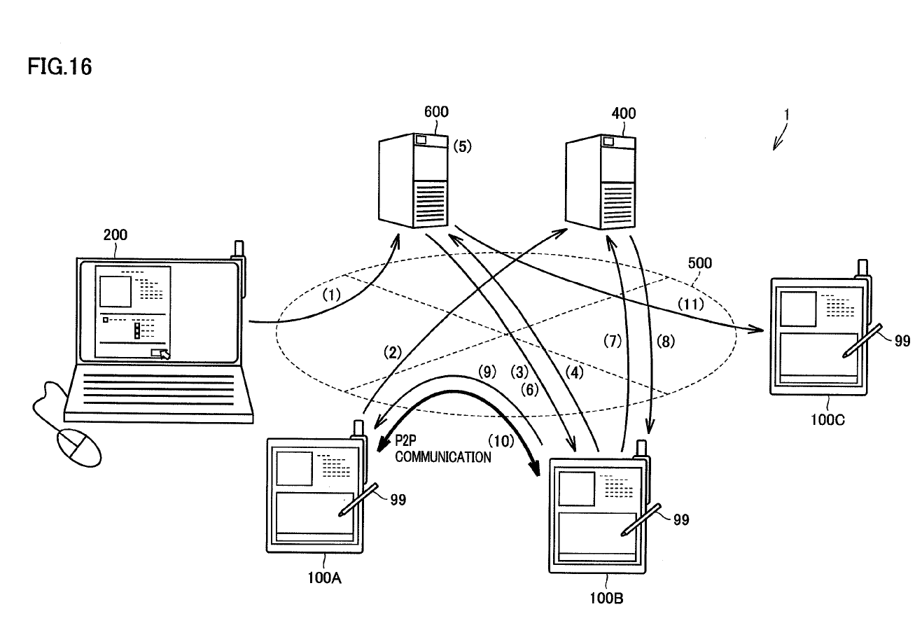

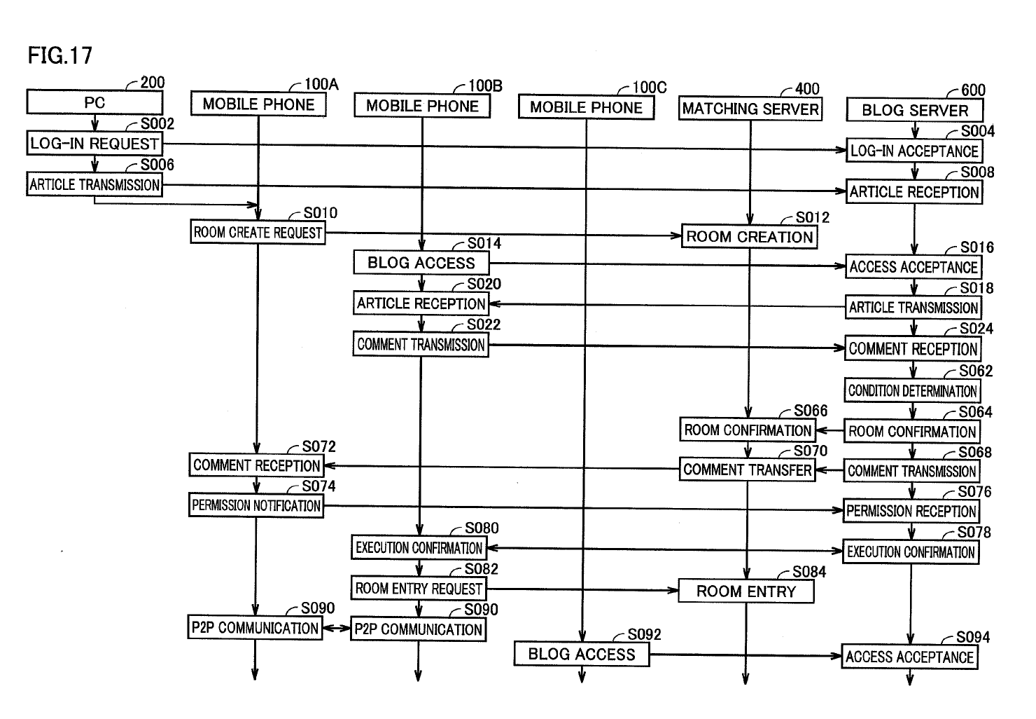

First, an operation profile of network system 1 of the present embodiment will be described. FIG. 16 is a schematic diagram of network system 1 of the present embodiment. FIG. 17 represents the sequence of the operation profile of network system 1 of the present embodiment.

Referring to FIGS. 3, 16 and 17, PC 200 used by the blog establisher request blog server 600 for the log-in to the blog service (step S002). Blog server 600 receives the request from PC 200 to permit posting an article by PC 200 (step S004).

Upon the blog establisher entering an article at PC 200, PC 200 transmits the relevant article to blog server 600 (step S006, FIG. 16 (1)). At this stage, PC 200 accepts from the blog establisher a chat condition to carry out a chat communication, and transmits the chat condition to blog server 600. Blog server 600 receives and stores the article and/or chat condition (step S008). Thereafter, blog server 600 responds to a request from a communication terminal to transmit the relevant article to the relevant communication terminal. As shown in FIG. 3 (A) PC 200 displays a page (article) subsequent to posting the article.

First mobile phone 100A used by the blog establisher transmits a request to create a chat room to matching server 400 (step S010). The relevant request includes a room name, the IP address of first mobile phone 100A, and the like. Matching server 400 receives the request to create the chat room having the relevant room name (step S012), FIG. 16 (2)). Matching server 400 stores the room name and IP address of first mobile phone 100A in correspondence.

Every time PC 200 transmits a new article to blog server 600, mobile phone 100A causes matching server 400 to create a chat room. It is to be noted that first mobile phone 100A may encompass the function of PC 200. Namely, mobile phone 100A may upload the article to blog server 600, and create a chat room at matching server 400.

Second mobile phone 100B responds to a command from a blog viewer to access blog server 600 (step S014). Specifically, second mobile phone 100B requests transmission of the article from blog server 600 (step S014). Blog server 600 accepts access from second mobile phone 100B (step S016).

Blog server 600 transmits the article and access information to second mobile phone 100B (step S018). Second mobile phone 100B receives the article and access information (step S020), FIG. 16 (3)), and shows the relevant article on the display. At this stage, second mobile phone 100B provides the display of a screen, as shown in FIG. 3 (A).

As shown in FIG. 3 (B), second mobile phone 100B accepts entry of a comment from a blog viewer, and transmits the relevant comment to blog server 600 (step S022), FIG. 1 (4)). Blog server 600 receives the comment from second mobile phone 100B, and stores the comment in correspondence with the article. Thereafter, blog server 600 responds to a request from a communication terminal to down load an article and comment to the relevant communication terminal.

Blog server 600 determines whether the contents of the input comment or the point of time at which the comment was input satisfies the chat condition or not (step S062, FIG. 16 (5)). For example, in the case where the chat condition includes a keyword, blog server 600 determines whether the comment includes the keyword or not. Alternatively, in the case where the posting point of time of the article and a specified time or specified point of time are included in the chat condition, blog server 600 determines whether the transmitted point of time of the comment is prior to the specified point of time (point of time of posting+specified time).

When the contents of the input comment or the entered time of the comment satisfies the chat condition, blog server 600 determines whether the chat room is created at matching server 400 based on the room name (step S064, step S066). Blog server 600 transmits the comment and the IP address of first mobile phone 100A to matching server 400 (step S068).

Matching server 400 transfers the comment and the IP address of second mobile phone 100B to first mobile phone 100A based on the IP address corresponding to the room name (step S070). As shown in FIG. 3 (C), first mobile phone 100A accepts the comment from matching server 400 (step S072), and provides a display of the comment for the blog establisher.

Upon accepting a command asking for chat communication from a blog viewer, first mobile phone 100A notifies second mobile phone 100B that the chat is permitted based on the IP address of second mobile phone 100B (step S074). Blog server 600 receives the permission of a chat communication (step S076). Blog server 600 confirms with second mobile phone 100B about whether a chat communication is to be executed or not (step S078, step S080).

As shown in FIG. 3 (D), second mobile phone 100B accepts a command asking for a chat communication from a blog viewer. Second mobile phone 100B responds to this command to transmit a request for entering the chat room having the relevant room name to matching server 400, based on the room name (step S082, FIG. 16 (7)).

Matching server 400 allows second mobile phone 100B to enter the chat room (step S084). Namely, matching server 400 stores the IP address of second mobile phone 100B and the room name in correspondence.

Matching server 400 transmits the IP address of first mobile phone 100A to second mobile phone 100B (FIG. 16 (8)). Second mobile phone 100B accesses first mobile phone 100A based on the IP address of first mobile phone 100A (FIG. 16 (9)).

As shown by (E) and (F) in FIG. 3, first mobile phone 100A and second mobile phone 100B conduct a chat communication with each other based on the IP address of the other party (step S090).

Then, third mobile phone 100C responds to a command from a blog viewer to access blog server 600 (step S092). Specifically, third mobile phone 100C requests transmission of the article from blog server 600. Blog server 600 accepts access from third mobile phone 100C (step S094).

By the configuration set forth above, network system 1 of the present embodiment determines whether blog server 600 permits a chat communication with first mobile phone 100A and second mobile phone 100B according to the comment transmitted by second mobile phone 100B. Namely, a chat communication between first mobile phone 100A and second mobile phone 100B is started or not started depending upon the contents or timing of the comment entered by a blog viewer.

In other words, the blog establisher in network system 1 of the present embodiment can readily select a blog viewer who has entered her/his desired comment and/or who has entered a comment at her/his desired time to conduct a chat communication.

In the present embodiment, a chat communication is carried out between first mobile phone 100A (the terminal of the blog establisher) and second mobile phone 100B (the terminal of the blog viewer). However, a chat communication may be carried out between second mobile phone 100B (terminal of the blog viewer) and a third mobile phone 100C (a terminal of a blog viewer). In this case, the comment from second mobile phone 100B corresponds to the article from the first mobile phone 100A, whereas the comment from third mobile phone 100C corresponds to the comment from second mobile phone 100B.

Namely, the blog viewer enters a chat condition, and second mobile phone 100B transmits the comment and access information for connection with second mobile phone 100B to blog server 600 (up load). Blog server 600 transmits the room name for communication to third mobile phone 100B when the comment entered at third mobile phone 100C satisfies the chat condition.

A configuration to realize the feature set forth above will be described in detail hereinafter.

<Hardware Configuration>

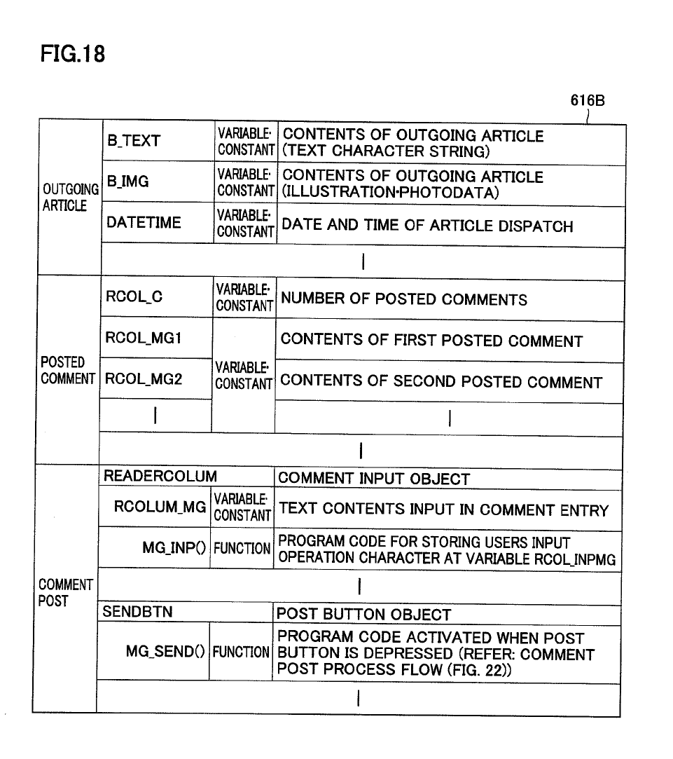

As mentioned above, the description of the hardware configuration of each device in network system 1 of the present embodiment will not be repeated. However, the data stored in memory 616 of blog server 600 in the present embodiment differs from that of the first embodiment. The data stored in memory 616 of blog server 600 will be described hereinafter. FIG. 18 is a pictorial representation of blog data 616B stored in memory 616 according to the present embodiment.

Referring to FIG. 18, data 616B stored in memory 616 of blog server 600 of the present embodiment differs from data 103B stored in memory 103 of first mobile phone 100A of the first embodiment in that information related to the chat is absent. Namely, memory 616 of blog server 600 stores information related to the outgoing article, information related to already posted comments, and information related to a comment currently created.

<Function Configuration of Network System>

The function of each of first mobile phone 100A, second mobile phone 100B, matching server 400 (second server), and blog server 600 (first server) in network system 1 of the present embodiment will be described hereinafter. In the following, description will be provided taking first mobile phone 100A as the communication terminal used by the blog establisher, whereas second mobile phone 100B and third mobile phone 100C are taken as communication terminals used by blog viewers.

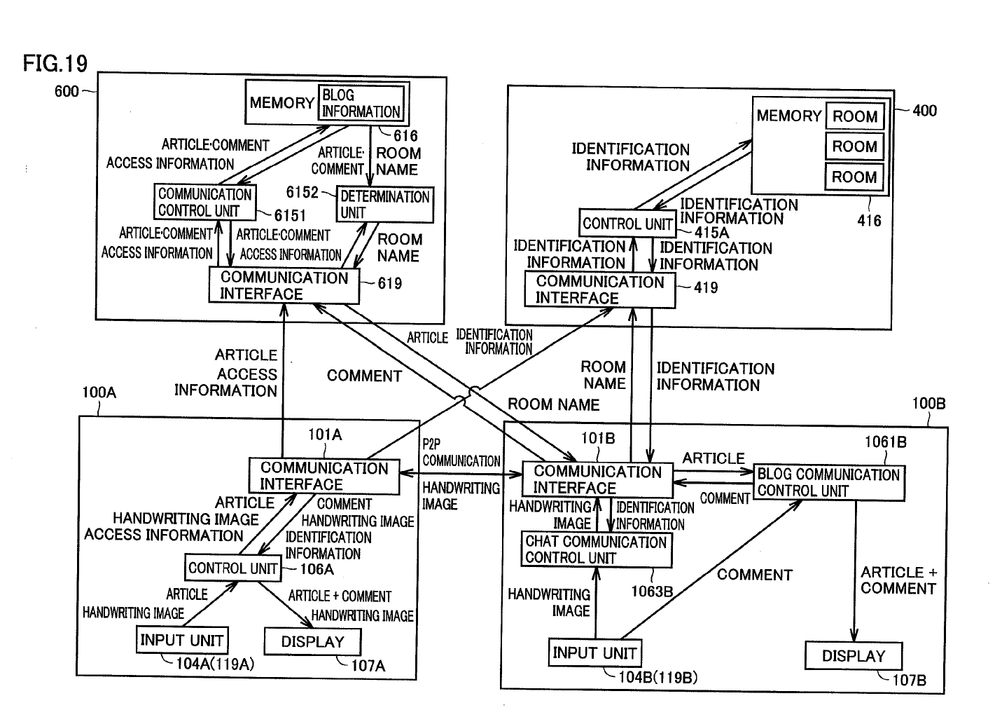

FIG. 19 is a block diagram representing a function configuration of each device in network system 1 of the present embodiment. The function configuration of first mobile phone 100A of the present embodiment is similar to that of the first embodiment. Therefore, description thereof will not be repeated.

Referring to FIG. 19, first the function configuration of blog server 600 of the present embodiment will be described. Blog server 600 includes a communication control unit 6151, a determination unit 6152, a memory 616, and a communication interface 619.

As mentioned above, communication interface 619 is realized by a communication antenna and/or signal processor not shown. Communication interface 619 transmits/receives various data to/from a communication terminal via Internet 500 or the like. Communication interface 619 of the present embodiment receives an article and/or comment from a communication terminal via Internet 500 and transmits the relevant article and/or comment via Internet 500 to another communication terminal.

Communication control unit 6151 and determination unit 6152 are functions implemented by CPU 615 and a control program stored in memory 616. Specifically, each function of communication control unit 6151 and determination unit 6152 are functions (modules) realized by CPU 615 executing a control program stored in memory 616 and the like to control each hardware shown in FIG. 4. For example, CPU 615 implements a functional block corresponding to communication control unit 6151 and determination unit 6152 by reading out a program prestored in HDD 617 and the like into a memory 616 such as an S-RAM for execution.

Communication control unit 6151 receives, via communication interface 619, access information related to first mobile phone 100A and an article from first mobile phone 100A, and stores the relevant access information and article in memory 616. Communication control unit 6151 responds to a request from second mobile phone 100B to transmit the relevant article to second mobile phone 100B via communication interface 619.

Communication control unit 6151 receives access information related to second mobile phone 100B and a comment from second mobile phone 100B via communication interface 619, and stores the relevant access information and comment in memory 616. Communication control unit 6151 responds to a request from first mobile phone 100A or third mobile phone 100C to transmit the relevant comment to first mobile phone 100A or third mobile phone 100C via communication interface 619.

When communication control unit 6151 receives a comment from second mobile phone 100B, determination unit 6152 determines whether the input (transmission) of the comment satisfies the chat condition included in the access information based on the access information from first mobile phone 100A.

For example, when the chat condition includes a keyword, determination unit 6152 determines whether the predetermined condition is satisfied or not by determining whether the input (transmitted) comment includes the keyword or not.

When the chat condition includes an NG word, determination unit 6152 determines whether the predetermined condition is satisfied or not by determining whether the input (transmitted) comment includes the NG word or not.

In the case where the chat condition includes a posting time and a chat allowable term, determination unit 6152 determines whether the predetermined condition is satisfied or not by determining whether the comment input point of time (transmission point of time) is within a chat allowable term from the posted time.

When determination unit 6152 determines that the input (transmission) of the relevant comment satisfies the chat condition included in the access information, communication control unit 6151 transmits the room name to second mobile phone 100B via communication interface 619.

A function configuration of second mobile phone 100B of the present embodiment will be described hereinafter. Second mobile phone 100B includes a communication interface 101B, a blog communication control unit 1061B, a determination unit 1062B, a display 107B, and an input unit 104B (tablet 119B). As set forth above, second mobile phone 100B also includes memory 103, clock unit 105, and the like.

Input unit 104B accepts the entry of a comment (second information) from the user to provide the relevant comment to control unit 106 realizing blog communication control unit 1061B and determination unit 1062B. CPU 106 stores the relevant comment in memory 103. Tablet 119 accepts a handwritten image (third information) from the user to provide the handwritten image to CPU 106. CPU 106 stores the handwritten image in memory 103.

Display 107B displays text such as an article or comment and/or an image such as an illustration or picture, based on the data from CPU 106. In the present embodiment, display 107B shows an article, comment, handwritten image, and the like based on the data from CPU 106.

Communication interface 101B is realized by a communication antenna and/or signal processor not shown. Communication interface 101B transmits various data to blog server 600, matching server 400, and/or another communication terminal via Internet 500 and the like, and receives various data from blog server 600, matching server 400, and/or another communication terminal. Communication interface 101B of the present embodiment transmits the comment to blog server 600 via Internet 500. Communication interface 101B transmits/receives a handwritten image during chat communication to/from second mobile phone 100B.

Blog communication control unit 1061B and chat communication control unit 1063B are realized by CPU 106 and a control program stored in memory 103. Specifically, each function (module) of CPU 106 is realized by CPU 106 executing a control program stored in memory 103 and the like to control each hardware shown in FIG. 4. For example, CPU 106 implements functional blocks corresponding to blog communication control unit 1061B and chat communication control unit 1063B by reading out a program prestored in a ROM, HDD, or the like constituting the non-volatile memory of memory 103 into an S-RAM realizing a work memory of the same memory 103 for execution.

As shown in FIG. 9, blog communication control unit 1061B receives access information and an article from blog server 600 to cause display 107A to show the article. Blog communication control unit 1061B causes display 107A to show text 107c for comment entry, and accepts a comment via input unit 104. Blog communication control unit 1061B uses communication interface 101B to transmit the comment accepted from a user to blog server 600 via Internet 500.

Blog communication control unit 1061B receives from blog server 600 the article posted by first mobile phone 100A and the comment posted by second mobile phone 100B, as the contents of the blog subsequent to comment posting. As shown in FIG. 10, blog communication control unit 1061B causes display 107 to show the contents of the blog subsequent to comment posting.

Chat communication control unit 1063B requests the IP address of first mobile phone 100A from matching server 400 based on the room name from blog server 600.

Chat communication control unit 1063B uses communication interface 101B to carry out a chat communication with first mobile phone 100A based on the IP address from matching server 400. During the chat communication, chat communication control unit 1063B transmits the handwritten image and/or comment accepted from the user via tablet 119B and/or input unit 104B to first mobile phone 100A based on the IP address of first mobile phone 100A using communication interface 101B. Chat communication control unit 1063B uses communication interface 101B to receive the handwritten image and/or comment from first mobile phone 100A.

The function configuration of matching server 400 of the present embodiment is similar to that of the first embodiment. Therefore, description thereof will not be repeated.

Moreover, the article post process of the present embodiment is similar to that of the first embodiment. Therefore, description thereof will not be repeated.

<Response Process at Blog Server>

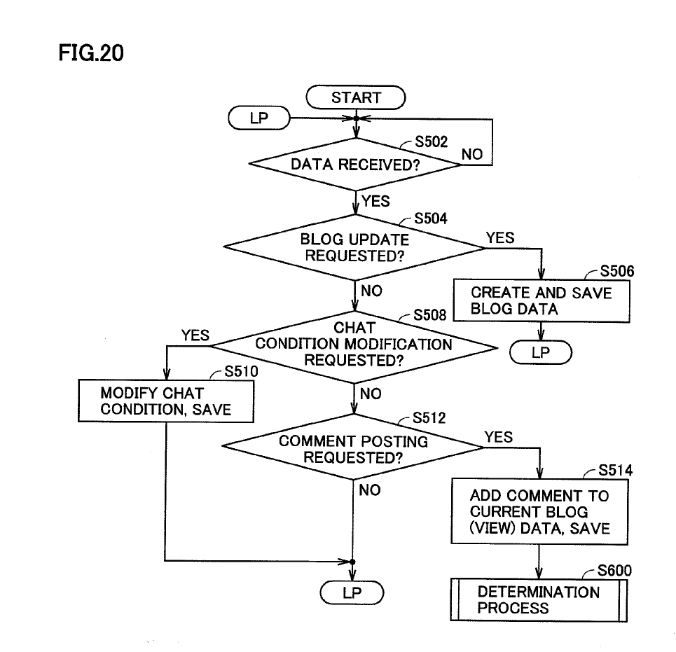

The procedure of a response process by blog server 600 according to the present embodiment will be described hereinafter. FIG. 20 is a flowchart of the procedure of a response process by blog server 600 of the present embodiment.

Referring to FIG. 20, CPU 615 determines whether data is received from a communication terminal via communication interface 619 (step S502). When data is not received (NO at step S502), CPU 615 repeats the process from step S502.

When data is received (YES at step S502), CPU 615 determines whether the relevant data is a blog update request or not (step S504). When a blog update request is accepted (YES at step S504), CPU 106 generates blog data and stores the data at a predetermined address in memory 616, based on the article included in the blog request (step S506). CPU 615 repeats the process from step S502.

When a blog update request is not received (NO at step S504), CPU 615 determines whether the relevant data is a request of modifying the chat condition (step S508). When a chat condition modify request is accepted (YES at step S508), CPU 106 modifies the chat condition, and stores the modified chat condition at a predetermined address in memory 616 (step S510). CPU 615 repeats the process from step S502.

When a chat condition modify request is not accepted (NO at step S508), CPU 106 determines whether the relevant data is a comment post request or not (step S512). When a comment post request is not received (NO at step S512), CPU 106 repeats the process from step S502.

When a comment post request is received (YES at step S512), CPU 106 adds the comment to the current blog data, and stores the new blog data at a predetermined address in memory 616 (step S514). CPU 615 executes the determination process.

<Determination Process>

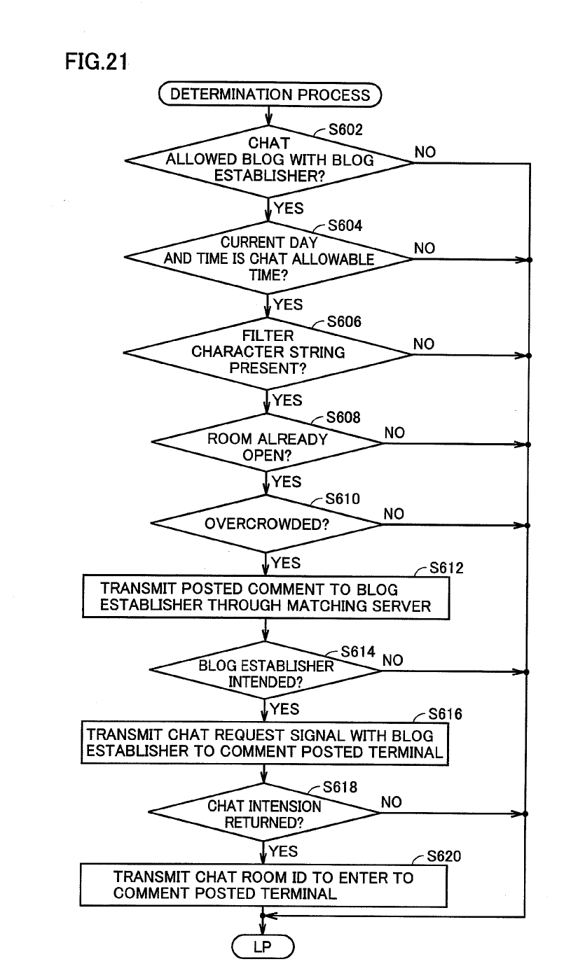

The procedure of a determination process of a blog server 600 of the present embodiment will be described hereinafter. FIG. 21 is a flowchart of the procedure of the determination process at blog server 600 of the present embodiment.

Referring to FIG. 21, CPU 615 determines whether a chat with the blog establisher is allowed or not with respect to the blog viewed by second mobile phone 100B (step S602). Specifically, the access information from first mobile phone 100A includes data indicating whether a chat is permitted or not. CPU 615 determines whether a chat with the blog establisher related to the blog viewed by second mobile phone 100B is allowed or not based on the access information from first mobile phone 100A.

When a chat with the blog establisher is not allowed (NO at step S602), CPU 615 repeats the process from step S502.

When a chat with the blog establisher is allowed (YES at step S602), CPU 615 determines whether the current date and time belongs to a chat allowable time zone (step S604). When the current time and date does not belong to a chat allowable time zone (NO at step S604), i.e. the chat allowable time zone has ended, CPU 615 repeats the process from step S502.

When the current date and time belongs to a chat allowable time zone (YES at step S604), CPU 615 determines whether a filter character string (NG word) is included in the posted comment (step S606). When an NG word is included in the comment (YES at step S606), CPU 615 repeats the process from step S502.

When an NG word is not included in the comment (NO at step S606), CPU 615 asks whether the chat room is already open or not at matching server 400 via communication interface 619 (step S608). When the chat room is not yet open (NO at step S608), CPU 615 repeats the process from step S502.

When the chat room is already open (YES at step S608), CPU 615 determines whether the number of participants entering the chat room has arrived at the quota (step S610). When the number of participants entering the chat room has arrived at the quota (YES at step S610), CPU 615 repeats the process from step S502.

When the number of participants entering the chat room has not arrived at the quota (NO at step 610), CPU 615 transmits the posted comment through matching server 400 to the communication terminal of the blog establisher via communication interface 619 (step S612). CPU 615 determines whether the blog establisher has permitted a chat communication at matching server 400 via communication interface 619 (step S614). When a chat communication is not permitted (NO at step S614), CPU 615 repeats the process from step S502.

When a chat communication is permitted (YES at step S614), CPU 615 transmits, via communication interface 619, a message requesting a chat communication with second mobile phone 100B (step S616). CPU 615 determines whether a chat communication with second mobile phone 100B is permitted or not (step S618). When a chat communication is not permitted at second mobile phone 100B (NO at step S618), CPU 615 repeats the process from step S502.

When a chat communication is permitted at second mobile phone 100B (YES at step S618), CPU 615 transmits the room name to enter the chat room of the matching server to second mobile phone 100B via communication interface 619 (step S620). CPU 615 repeats the process from steps S502.

<Comment Post Process>

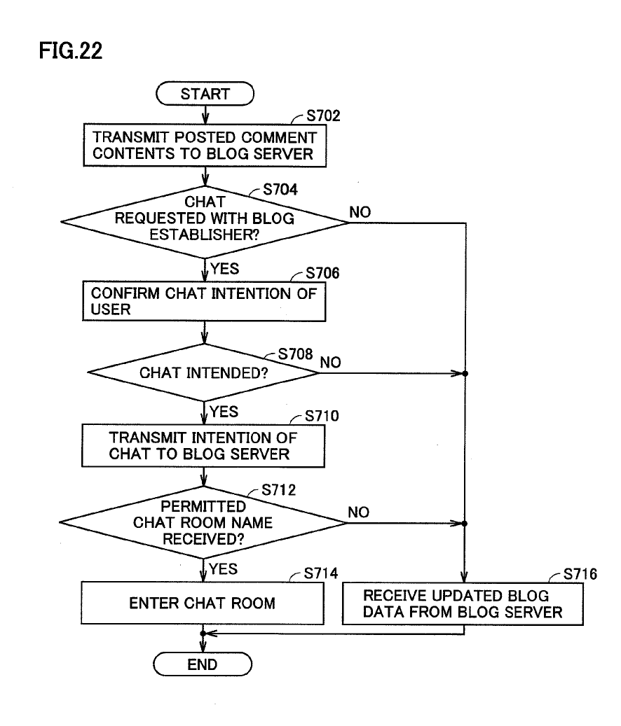

The procedure of a comment post process at a communication terminal identified as a blog viewer terminal of the present embodiment will be described hereinafter. FIG. 22 is a flowchart of the procedure of a comment post process at a communication terminal identified as a blog viewer terminal of the present embodiment.

Referring to FIG. 22, CPU 106 transmits the input comment to blog server 600 via communication interface 101 (step S702). CPU 106 determines whether a request for a chat communication is accepted from matching server 400 via communication interface 101 (step S704). When a request for a chat communication is not accepted (NO at step S704), CPU 106 receives updated blog data from blog server 600 via communication interface 101 (step S716).

When a request for a chat communication is accepted (YES at step S704), CPU 106 determines whether a command to carry out a chat communication is accepted from the user or not via input unit 104 or tablet 119 (step S706). When a command of carrying out chat communication is not accepted (NO at step S708), CPU 106 repeats the process from step S716.

When a command of carrying out a chat communication is accepted (YES at step S708), CPU 106 transmits a message to carry out a chat communication to blog server 600 via communication interface 101 (step S710). CPU 106 determines whether a room name is received or not from blog server 600 via communication interface 101 (step S712). When a room name is not received (NO at step S712), CPU 106 repeats the process from step S716.

When a room name is received (YES at step S712), CPU 106 enters the chat room of matching server 400 based on the relevant room name using communication interface 101 (step S714).

### Other Embodiments

It is needless to say that the present invention is applicable even in the case where a program is supplied to a system or device. A storage medium storing the program represented by software to carry out the present invention is supplied to a system or device. By causing the computer (or CPU or MPU) of that system or device to read out and execute the program code stored in the storage medium, the advantage of the present invention can be enjoyed.

In this case, the program code per se read out from the storage medium realizes the function of the embodiments set forth above, and the storage medium storing the program code constitutes the present invention.

For a storage medium to supply the program code, a hard disk, optical disk, magneto optical disk, CD-ROM, CD-R, magnetic tape, non-volatile memory card (IC memory card), ROM (mask ROM, flash EEPROM and the like), for example, may be used.

In addition to realizing the functions of the embodiments set forth above by executing a program code read out by a computer, the functions of the embodiments described above may be realized by a process according to an OS (Operating System) running on the computer performing a part of or all of the actual process, based on the commands of the relevant program codes.

Further, the program codes read out from a recording medium may be written to a memory included in a functionality expansion board inserted to a computer or a functionality expansion unit connected to a computer. Then, the functions of the embodiments described above may be realized by a process according to a CPU or the like provided on the functionality expansion board or the functionality expansion unit, performing a part of or all of the actual process, based on the commands of the relevant program codes.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### DESCRIPTION OF THE REFERENCE CHARACTERS

1 network system; 100A first mobile phone; 100B second mobile phone; 100C third mobile phone 100C; 101, 101A, 101B communication interface; 103, 103A, 103B memory; 104, 104A, 104B input unit; 105 clock unit; 106 CPU; 106A control unit; 1061 blog communication control unit; 1062 determination unit; 1063 chat communication control unit; 107, 107A, 107B display; 119 tablet; 200 personal computer; 400 matching server; 415A control unit; 416 memory; 419 communication interface; 500 Internet; 600 blog server, 615A control unit; 6151 communication control unit; 6152 determination unit; 616 memory, 619 communication interface.

1. A network system comprising a first terminal, a second terminal, and a first server, said first terminal including
a first input unit for accepting first information,
a first terminal interface for communication with said second terminal and said first server,
a first display for displaying said first information and second information from said second terminal, and
a first terminal control unit for transmitting access information for connection with said first terminal and said first information to said first server via said first terminal interface,
said first server including
a server interface for communication with said first terminal and said second terminal, and
a server control unit for transmitting said access information and said first information to said second terminal via said server interface, and transmitting said second information from said second terminal to said first terminal via said server interface,
said second terminal including
a second input unit for accepting said second information,
a second terminal interface for communication with said first terminal and said first server,
a second display for displaying said first information from said first server and said second information,
a first communication control unit receiving said access information and said first information from said first server via said second terminal interface, and transmitting said second information to said first server via said second terminal interface,
a determination unit for determining whether input of said second information satisfies a predetermined condition or not based on said access information, and
a second communication control unit exchanging third information with said first terminal via said second terminal interface based on said access information, when input of said second information satisfies said predetermined condition.

2. The network system according to claim 1, further comprising a second server, wherein
said access information includes a room name,
said first terminal control unit transmits said room name and identification information for identifying said first terminal to said second server via said first terminal interface,
said second server stores said room name and said identification information in correspondence,
said second communication control unit
obtains said identification information from said second server based on said room name via said second terminal interface when input of said second information satisfies said predetermined condition, and
exchanges said third information with said first terminal via said second terminal interface based on said identification information.

3. The network system according to claim 1, wherein
said first input unit accepts a keyword,
said access information includes said keyword,
said determination unit determines whether input of said second information satisfies the predetermined condition or not by determining whether said second information includes said keyword or not.

4. The network system according to claim 1, wherein
said access information includes a first point of time at which said first terminal transmitted said first information,
said determination unit determines whether input of said second information satisfies said predetermined condition or not by determining whether a time starting from said first point of time until a second point of time at which said second terminal transmitted said second information is shorter than a first period of time.

5. A communication terminal comprising:
an input unit for accepting second information,
an interface for communication with another terminal and a first server,
a display for displaying first information from said first server and said second information,
a first communication control unit receiving access information for connection with said other terminal and said first information via said interface, and transmitting said second information to said first server via said interface,
a determination unit for determining whether input of said second information satisfies a predetermined condition or not based on said access information, and
a second communication control unit for exchanging third information with said other terminal via said interface based on said access information, when input of said second information satisfies said predetermined condition.

6. A communication method at a network system including a first terminal, a second terminal, and a first server, said communication method comprising the steps of:
said first terminal accepting first information,
said first terminal transmitting access information for connection with said first terminal and said first information to said first server,
said first server transmitting said access information and said first information to said second terminal,
said second terminal receiving said access information and said first information from said first server,
said second terminal accepting second information,
said second terminal transmitting said second information to said first server,
said second terminal displaying said first information from said first server and said second information,
said first server transmitting said second information from said second terminal to said first terminal,
said first terminal displaying said first information and said second information from said second terminal,
said second terminal determining whether input of said second information satisfies a predetermined condition or not based on said access information, and
said second terminal exchanging third information with said first terminal based on said access information, when input of said second information satisfies said predetermined condition.

7. A communication method at a communication terminal including a control unit, an input unit, a display, and an interface for communication with another terminal and a first server, said communication method comprising the steps of:
said control unit receiving access information for connection with said other terminal and said first information from said first server via said interface,
said input unit accepting second information,
said control unit transmitting said second information to said first server via said interface,
said control unit causing said display to display said first information from said first server and said second information,
said control unit determining whether input of said second information satisfies a predetermined condition or not based on said access information, and
said control unit exchanging third information with said other terminal via said interface based on said access information, when input of said second information satisfies said predetermined condition.

8. A communication program for causing communication by a communication terminal including a control unit, an input unit, a display, and an interface for communication with another terminal and a first server, said communication program causing said control unit to execute the steps of:
receiving access information for connection with said other terminal and said first information from said first server via said interface,
accepting second information via said input unit,
transmitting said second information to said first server via said interface,
causing said display to display said first information from said first server and said second information,
determining whether input of said second information satisfies a predetermined condition or not based on said access information, and
exchanging third information with said other terminal via said interface based on said access information, when input of said second information satisfies said predetermined condition.

9. A network system comprising a first terminal, a second terminal, and a first server, said first terminal including
a first input unit for accepting first information,
a first terminal interface for communication with said second terminal and said first server,
a first display for displaying said first information and second information from said second terminal, and
a first terminal control unit for transmitting access information for connection with said first terminal and said first information to said first server via said first terminal interface,
said first server including
a server interface for communication with said first terminal and said second terminal,
a determination unit for determining whether input of said second information satisfies a predetermined condition or not at said second terminal, based on said access information, and
a server communication control unit transmitting said first information to said second terminal via said server interface, transmitting said second information from said second terminal to said first terminal via said server interface, and transmitting a portion of said access information to said second terminal via said server interface, when input of said second information satisfies the predetermined condition,
said second terminal including
a second input unit for accepting said second information,
a second terminal interface for communication with said first terminal and said first server,
a second display for displaying said first information from said first server and said second information,
a first communication control unit for receiving said first information and a portion of said access information from said first server via said second terminal interface, and transmitting said second information to said first server via said second terminal interface, and
a second communication control unit for exchanging third information with said first terminal via said second terminal interface based on the portion of said access information.

10. The network system according to claim 9, further comprising a second server, wherein
said access information includes a room name,
said first terminal control unit transmits said room name and identification information for identifying said first terminal to said second server via said first terminal interface,
said second server stores said room name and said identification information in correspondence,
said server communication control unit transmits said room name as a portion of said access information to said second terminal via said server interface, when input of said second information satisfies said predetermined condition,
said second communication control unit
obtains said identification information from said second server based on said room name via said second terminal interface, and
exchanges said third information with said first terminal via said second terminal interface based on said identification information.

11. The network system according to claim 9, wherein
said access information includes a keyword,
said determination unit determines whether input of said second information satisfies the predetermined condition or not by determining whether said second information includes said keyword or not.

12. The network system according to claim 9, wherein
said access information includes a first point of time at which said first terminal transmitted said first information,
said determination unit determines whether input of said second information satisfies said predetermined condition or not by determining whether a time starting from said first point of time until a second point of time at which said second terminal transmitted said second information is shorter than a first period of time.

13. A communication method at a network system including a first terminal, a second terminal, and a first server, the communication method comprising the steps of:
said first terminal accepting first information,
said first terminal transmitting access information for connection with said first terminal and said first information to said first server,
said first server transmitting said access information and said first information to said second terminal,
said second terminal receiving said first information from said first server,
said second terminal accepting second information,
said second terminal transmitting said second information to said first server,
said second terminal displaying said first information from said first server and said second information,
said first server transmitting said second information from said second terminal to said first terminal,
said first terminal displaying said first information and the second information from said second terminal,
said first server determining whether input of said second information satisfies a predetermined condition or not,
said first server transmitting a portion of said access information to said second terminal, when input of said second information satisfies the predetermined condition, and
said second terminal exchanging third information with said first terminal based on the portion of said access information.
